(19) United States
(12) Patent Application Publication
(10) Pub. No.: US 2023/0341355 A1
(43) Pub. Date: Oct. 26, 2023

(54) SENSOR-BASED HIGH-THROUGHPUT MATERIAL CHARACTERIZATION PLATFORM AND METHODS OF USE THEREOF

(71) Applicant: VIRGINIA TECH INTELLECTUAL PROPERTIES, INC., Blacksburg, VA (US)

(72) Inventors: Blake JOHNSON, Pembroke, VA (US); Alexander HARING, Blacksburg, VA (US); Manjot SINGH, Blacksburg, VA (US); Junru ZHANG, Blacksburg, VA (US)

(21) Appl. No.: 17/918,657

(22) PCT Filed: Apr. 15, 2021
(86) PCT No.: PCT/US2021/027521

§ 371 Date: Oct. 13, 2022

Related U.S. Application Data
(60) Provisional application No. 63/010,621, filed on Apr. 15, 2020.

(51) Int. Cl. G01N 29/036; G01N 35/00; G01N 29/24; G01N 29/275

(52) U.S. Cl. CPC G01N 29/036; G01N 35/0099; G01N 29/2437; G01N 29/275; G01N 2291/014; G01N 2291/022; G01N 2291/101

(57) ABSTRACT

Systems and methods for measuring physical material properties of a plurality of samples with high throughput can be carried out with high reliability. The system can include a three-axis robotic structure for moving the target to a desired position in a three-dimensional space, a piezoelectric millimeter cantilever sensor mounted on the three-axis robotic structure, the piezoelectric millimeter cantilever sensor configured to have at least one electrical parameter as a function of its physical environment, and a controller configured to instruct the three-axis robotic structure to position the millimeter cantilever sensor at a first position over a first well including a first fluid sample, instruct the three-axis robotic structure to lower the piezoelectric millimeter cantilever sensor into the first fluid sample, instruct the three-axis robotic structure to retract the piezoelectric millimeter cantilever and move it over a second position over, and lower into a second well including a second fluid sample.

### CROSS-REFERENCE TO RELATED APPLICATIONS

This application claims priority to U.S. Provisional Patent Application No. 63/010,621, entitled “SENSOR-BASED HIGH-THROUGHPUT CHARACTERIZATION RHEOLOGY PLATFORM AND METHODS OF USE THEREOF,” filed Apr. 15, 2020, the entirety of which is incorporated by reference herein.

### STATEMENT REGARDING FEDERALLY SPONSORED RESEARCH OR DEVELOPMENT

This invention was made with government support under award 1739318 awarded by the National Science Foundation. The government has certain rights in the invention.

### TECHNICAL FIELD

The present disclosure generally relates to sensor systems and methods of use thereof.

### BACKGROUND

Hydrogels are crosslinked polymer networks that contain high water content. The past two decades have seen a sharp rise in fundamental research involving hydrogels and the development of hydrogels for various applications in energy storage and biotechnology (Madhumitha et al. 2018, Stephan 2006, Wu et al. 2013, Xu et al. 2013) The need for controlled drug release systems was among the earliest driving forces for hydrogel research in the pharmaceutical sciences (Gupta et al. 2002). In addition to the ability to incorporate drugs, the ability to incorporate animal cells has led to the widespread use of hydrogels in 3D cell culture and tissue engineering applications (Lee et al. 2008, Tibbitt et al. 2009). For example, a number of studies have shown that the gene expression profiles of cells differ in monolayer tissue culture environments (i.e., 2D substrates) vs. 3D matrices, which is often attributed to differences in cell-cell and cell-matrix interactions (Tibbitt et al. 2009). Hydrogels have emerged as attractive materials for regenerative medicine applications, including 3D-bioprinted tissues and injectable scaffolds for wound healing and tissue regeneration (Duan et al. 2013, Haring et al. 2017, Haring et al. 2019, Highley et al. 2015). In combination with their use as energy storage devices (e.g., gel electrolytes for lithium ion batteries), (Stephan 2006, Wu et al. 2013) passive drug release systems, (Gupta et al. 2002, Li et al. 2016) tissue scaffolds, (Drury et al. 2003, Lee et al. 2001), and sensors, (Gerlach et al. 2005, Richter et al. 2008) emerging applications to soft actuators, active drug release systems, and complex engineered tissues have driven research on stimuli-responsive hydrogels—for example, in soft robotics and 4D bioprinting fields (Bakarich et al. 2015, Gladman et al. 2016). In such applications, the characterization of hydrogel structure, physical properties, and rheological properties (e.g., crystal structure, dielectric properties, and viscoelastic properties) serve as important indicators of the material's processability, performance, quality, and response to stimuli. Therefore, identifying new paradigms for the characterization of hydrogels and other gel-based materials is central to accelerating the pace of gel-based materials research and improving the processability and quality of gel-based therapeutics, devices, and other products.

### SUMMARY

In one aspect of the disclosure, a system for measuring physical material properties of a plurality of samples includes a three-axis robotic structure for moving the target to a desired position in a three-dimensional space, a piezoelectric millimeter cantilever sensor mounted on the three-axis robotic structure, the piezoelectric millimeter cantilever sensor configured to have at least one electrical parameter as a function of its physical environment, and a controller coupled with the three-axis robotic structure. The controller is configured to instruct the three-axis robotic structure to position the millimeter cantilever sensor at a first position over a first well including a first fluid sample. The controller is further configured to instruct the three-axis robotic structure to lower the piezoelectric millimeter cantilever sensor into the first fluid sample, and instruct the three-axis robotic structure to retract the piezoelectric millimeter cantilever sensor from the first fluid sample and move the piezoelectric millimeter cantilever sensor over a second position over a second well including a second fluid sample. The controller is further configured to instruct the three-axis robotic structure to lower the piezoelectric millimeter cantilever sensor into the second fluid sample.

In some embodiments, the controller is further configured to measure at least one electrical parameter associated with the piezoelectric millimeter cantilever sensor when the piezoelectric millimeter cantilever sensor is lowered into each of the first fluid sample and the second fluid sample. In some embodiments, the controller is further configured to measure a first set of electrical parameters associated with the piezoelectric millimeter cantilever sensor after instructing the three-axis robotic structure to lower the piezoelectric millimeter cantilever sensor into the first fluid sample, determine that a value of at least one electrical parameter from the set of electrical parameters is in a steady state, and based on determining that the value is in a steady state, instruct the three-axis robotic structure to retract the piezoelectric millimeter cantilever sensor from the first fluid sample. In some embodiments, the controller is configured to determine that the value of the at least one electrical parameter from the set of electrical parameters is in the steady state based on determining that a rate of change of the value of the at least one electrical parameter from the set of electrical parameters is below a threshold value.

In some embodiments, the controller is further configured to prior to instructing the three-axis robotic structure to move the piezoelectric millimeter cantilever over the second position over the second well, instruct the three-axis robotic structure to lower and retract the piezoelectric millimeter cantilever sensor into a third well having a washing fluid. In some embodiments, the controller is further configured to determine that a value of at least one electrical parameter after instructing the three-axis robotic structure to retract the piezoelectric millimeter cantilever sensor from the first fluid sample, determine that the value of the at least one electrical parameter is below a threshold value, and based on determining that the value of the at least one electrical parameter is below the threshold value, instruct the three-axis robotic structure to lower the piezoelectric millimeter cantilever sensor into the third well having the washing fluid.

In some embodiments, the controller is further configured to repeatedly measure a value of at least one electrical parameter associated with the piezoelectric millimeter cantilever sensor after instructing the three-axis robotic structure to lower the piezoelectric millimeter cantilever sensor into the first fluid sample, and instruct the three-axis robotic structure to stop lowering the piezoelectric millimeter cantilever sensor into the first fluid sample upon determining that the value of the at least one electrical parameter is less than a submersion threshold value. In some embodiments, the system further includes a well plate including a plurality of wells, including the first well and the second well, each well of the plurality of well having an opening that can accommodate at least a portion of the piezoelectric millimeter cantilever sensor.

In another aspect of the disclosure a method for measuring material composition, structure, and properties of a plurality of samples uses a system including a three-axis robotic structure for moving the target to a desired position in a three-dimensional space, and a piezoelectric millimeter cantilever sensor mounted on the three-axis robotic structure, the piezoelectric millimeter cantilever sensor configured to have at least one electrical parameter as a function of its physical environment. The method includes positioning, by the three-axis robotic structure, the millimeter cantilever sensor at a first position over a first well including a first fluid sample. The method further includes lowering, by the three-axis robotic structure, the piezoelectric millimeter cantilever sensor into the first fluid sample. The method also includes retracting, by the three-axis robotic structure, the piezoelectric millimeter cantilever sensor from the first fluid sample and moving the piezoelectric millimeter cantilever sensor over a second position over a second well including a second fluid sample, and lowering, by the three-axis robotic structure, the piezoelectric millimeter cantilever sensor into the second fluid sample.

In some embodiments, the method further includes measuring at least one electrical parameter associated with the piezoelectric millimeter cantilever sensor when the piezoelectric millimeter cantilever sensor is lowered into each of the first fluid sample and the second fluid sample. In some embodiments, the method also includes measuring a first set of electrical parameters associated with the piezoelectric millimeter cantilever sensor after lowering the piezoelectric millimeter cantilever sensor into the first fluid sample, determining that a value of at least one electrical parameter from the set of electrical parameters is in a steady state, and retracting, based on determining that the value is in a steady state, the piezoelectric millimeter cantilever sensor from the first fluid sample.

In some embodiments, the method also includes determining that the value of the at least one electrical parameter from the set of electrical parameters is in the steady state based on determining that a rate of change of the value of the at least one electrical parameter from the set of electrical parameters is below a threshold value. In some embodiments, the method further includes prior to moving the piezoelectric millimeter cantilever over the second position over the second well, lowering, by the three-axis robotic structure, the piezoelectric millimeter cantilever sensor into a third well having a washing fluid. In some embodiments, the method also includes determining that a value of at least one electrical parameter retracting the piezoelectric millimeter cantilever sensor from the first fluid sample; determining that the value of the at least one electrical parameter is below a threshold value, and based on determining that the value of the at least one electrical parameter is below the threshold value, lowering, by the three-axis robotic structure, the piezoelectric millimeter cantilever sensor into the third well having the washing fluid. In some embodiments, the method further includes repeatedly measuring a value of at least one electrical parameter associated with the piezoelectric millimeter cantilever sensor after lowering the piezoelectric millimeter cantilever sensor into the first fluid sample, and stop lowering the piezoelectric millimeter cantilever sensor into the first fluid sample upon determining that the value of the at least one electrical parameter is less than a submersion threshold value.

In yet another aspect of the disclosure a non-volatile computer readable memory including instructions, which when executed by one or more processors, cause the one or more processors to execute a method. The method can include positioning, by a three-axis robotic structure, a millimeter cantilever sensor at a first position over a first well including a first fluid sample, wherein the three-axis robotic structure is configured to moving a target to a desired position in a three-dimensional space, and wherein the piezoelectric millimeter cantilever sensor is mounted on the three-axis robotic structure and is configured to have at least one electrical parameter as a function of its physical environment, lowering, by the three-axis robotic structure, the piezoelectric millimeter cantilever sensor into the first fluid sample, retracting, by the three-axis robotic structure, the piezoelectric millimeter cantilever sensor from the first fluid sample and moving the piezoelectric millimeter cantilever sensor over a second position over a second well including a second fluid sample, and lowering, by the three-axis robotic structure, the piezoelectric millimeter cantilever sensor into the second fluid sample.

In some embodiments, the method further includes measuring at least one electrical parameter associated with the piezoelectric millimeter cantilever sensor when the piezoelectric millimeter cantilever sensor is lowered into each of the first fluid sample and the second fluid sample. In some embodiments, the method also includes measuring a first set of electrical parameters associated with the piezoelectric millimeter cantilever sensor after lowering the piezoelectric millimeter cantilever sensor into the first fluid sample, determining that a value of at least one electrical parameter from the set of electrical parameters is in a steady state, and retracting, based on determining that the value is in a steady state, the piezoelectric millimeter cantilever sensor from the first fluid sample. In some embodiments, the method also includes determining that the value of the at least one electrical parameter from the set of electrical parameters is in the steady state based on determining that a rate of change of the value of the at least one electrical parameter from the set of electrical parameters is below a threshold value. In some embodiments, the method further includes prior to moving the piezoelectric millimeter cantilever over the second position over the second well, lowering, by the three-axis robotic structure, the piezoelectric millimeter cantilever sensor into a third well having a washing fluid.

Other systems, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1. A) Schematic of piezoelectric-excited millimeter cantilever (PEMC) sensor self-sensing and self-exciting design for sensor-based characterization of hydrogel rheological properties and real-time monitoring of sol-gel phase transitions. Photographs of a PEMC sensor from top-down (B) and side-view (C) perspectives. D) Sensor frequency response acquired via electrical impedance analysis shown in terms of the phase angle response (inset shows photograph of the PEMC sensor submerged in a concentrated solution of gel-forming polymer; spectra in air and vacuum correspond to 1 and 0.3 atm (vacuum), respectively).

FIG. 2. A) Schematic depicting the sensor-based sol-gel rheological characterization study and associated measurement principle (i.e., real-time monitoring of gelation processes via sensor signal tracking). Observed cantilever impedance phase angle over a 25-50 kHz sweep in air, solution (sol), and gel phases of 6 wt % gelatin (B), 0.25 wt % alginate (C), and 10 wt % PEGDA (D).

FIG. 3. Limits of resonance persistence in increasingly concentrated hydrogels. A) 6, 8, 10, and 12 wt % gelatin. B) 0.5, 1, 1.5, and 2 wt % alginate. C) 5, 10, 15, and 20 wt % PEGDA.

FIG. 4. Sensor resonant frequency (A), phase angle (B), and quality factor (C) responses associated with thermoreversible gelation of gelatin solutions (data shown for 8 wt % gelatin solutions). Total changes in sensor frequency (D), phase angle (E), and quality factor (F) upon gelation of 6, 8, and 10 wt % gelatin solutions (n=3 repeated studies per concentration). Sensor resonant frequency (G), phase angle (H), and quality factor (I) responses associated with chemical gelation of alginate solutions (data shown for 0.25 wt % alginate solutions). Total changes in sensor frequency (J), phase angle (K), and quality factor (L) upon gelation of 0.25, 0.5, and 0.75 wt % alginate solutions (n=3 repeats per concentration). Sensor time series data (i.e., panels A-C and G-I) is presented using a 5-point moving median filtering (red line indicates a 25-point moving average).

FIG. 5. Real-time monitoring of high-frequency shear moduli at the resonant frequency (˜35 kHz) based on sensor resonant frequency and quality factor responses using the cantilever viscoelastic material-structure interaction model throughout gelation of 8 wt % gelatin (A) and 0.5 wt % alginate (B) solutions (green and blue lines show 25-point moving averages associated with the storage and loss moduli response, respectively). High-frequency shear moduli obtained at the resonant frequency of hydrogels formed from 6, 8, and 10 wt % gelatin (C) and 0.25, 0.5, and 0.75 wt % alginate (D) solutions (n=3 experiments for each concentration). Sensor transfer functions associated with quality factor (Q) change vs. Gr′ and E′ with linear regressions shown (panels E and F, respectively).

FIG. 6. Benchmarking of cantilever sensor data against standard rheological characterization techniques. Comparison of storage (A) and loss (B) moduli at the resonant frequency obtained from sensor data with low-frequency viscoelastic moduli obtained via traditional DMA of gelatin and alginate hydrogels (error bars represent the standard deviation of n=3 repeated experiments). (C) Comparison of temporal responses of the high- and low-frequency shear moduli obtained from sensor data and traditional rheology (1 Hz), respectively, through the thermoreversible gelation of 8 wt % gelatin solutions.

FIG. 7. (A) shows fit of a modified Hill model to normalized sensor-derived storage modulus responses associated with the chemical gelatin of alginate solutions (sensor data presented as a 5-point moving average). Dependence of half-gelation time, e (B) and Hill coefficient, n (C) for 0.25, and characteristic rate, P (D) for chemical gelation 0.25, 0.5, and 0.75 wt % alginate solutions (error bars represent the standard deviation for n=3 repeated studies).

FIG. 8 shows sensor resonant frequency (A), phase angle (B), and quality factor (C) responses corresponding to the dissolution of alginate hydrogels. Alginate hydrogels formed by chemical gelation of alginate solutions using saturated CaCl₂) (applied at 400 s) were dissolved by application of a dissolving agent (1 M ethylenediaminetetraacetic acid (EDTA) solution; applied at 700 s; sensor responses presented as a 5-point moving median).

FIGS. 9A-9C show impedance magnitude spectra in air, solution phase, and gel phase for 6 wt % gelatin (A), 0.25 wt % alginate (B), and 10 wt % PEGDA (C).

FIGS. 10A-10C show real-time monitoring of sensor signals during UV curing of a 10 wt % PEGDA shown in terms of the resonant frequency (A), phase angle (B), and quality factor (C) responses. Exposure to a negative control (light on with UV blocked) at 200 s and exposure to UV light begins at 600 s.

FIG. 11 shows predicted gelation kinetic for chemical gelation of 0.25, 0.5, and 0.75 wt % alginate solutions based on the modified Hill modeling of associated sensor responses (n=3 experiments for each concentration).

FIGS. 12A-12C show (A) schematic of the sensor-based high-throughput characterization (HTC) system for rapid automated rheological characterization of gel-based materials and sol-gel systems in well-plate formats. Schematic representation of the characterization bottlenecks found in state-of-the-art accelerated material discovery workflows that arise from traditional low-throughput characterization equipment (B) and the potential for bottleneck mitigation through a paradigm shift toward HTC platforms (C).

FIGS. 13A-13B show a schematic of the sensor mechanical and electrical design and corresponding signal outputs and associated models (A: mechanical and B: electrical).

FIGS. 14A-14C depict a schematic showing the concept of the sensor motion path and measurement of samples with successively increasing polymer concentration (A), the resultant sensor data, phase behavior, and viscoelastic property structure (B), and generated sol-gel phase transition diagram on the concentration-temperature plane (C).

FIGS. 15A-15F show results of proof-of-concept studies using the sensor-based HTC platform for monitoring of sol-gel viscoelastic properties and gelation processes. Photographs of the sensor-based HTC platform (a-c). Representative sensor impedance data (d). Sensor data for measurements in 96-well plates showing resonant frequency, phase angle and impedance vs. time (in seconds). (e). Time-series data associated with mapping of the Pluronic F127-water sol-gel phase transition diagram (f).

FIG. 16 shows benchmarking of phase transition data acquired using the HTC platform vs. reported studies using Pluronic F127 hydrogels (curves show sol-gel transition).

FIG. 17 shows an example process for measuring material properties of a plurality of samples in a well plate.

FIG. 18 shows (A) Description of an experimental study that involving automated characterization of 12 samples of varying composition (Pluronic F127 (c)-water). PF127 solutions vary from 3-30 wt % across the plate; (B) Measurement description in terms of a phase diagram; (C-D) real-time sensor data acquired by the platform during the measurement, and (E) Resultant heat maps of sensor outputs measured for each material tested (which are equivalent to rheological properties of the material obtained either through on-plate calibration or fluid-structure interaction models).

FIG. 19 shows (A) description of an experimental study with altered wash configuration relative to that shown in FIG. 18 (end wash only); (B-C) real-time sensor data acquired during the automated test; and (D) Highlight of sensor output heat map for each sample evaluated generated by the platform.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

In some instances, units may be used herein that are non-metric or non-SI units. Such units may be, for instance, in U.S. Customary Measures, e.g., as set forth by the National Institute of Standards and Technology, Department of Commerce, United States of America in publications such as NIST HB 44, NIST HB 133, NIST SP 811, NIST SP 1038, NBS Miscellaneous Publication 214, and the like. The units in U.S. Customary Measures are understood to include equivalent dimensions in metric and other units (e.g., a dimension disclosed as “1 inch” is intended to mean an equivalent dimension of “2.5 cm”; a unit disclosed as “1 pcf” is intended to mean an equivalent dimension of 0.157 kN/m³; or a unit disclosed 100° F. is intended to mean an equivalent dimension of 37.8° C.; and the like) as understood by a person of ordinary skill in the art.

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

While emerging synthetic techniques, such as automated synthesizers and synthetic biology, are now being developed to produce materials with unprecedented throughput, characterization loops represent major bottlenecks in accelerated molecular and material discovery workflows (de Pablo et al. 2019, Green et al. 2017, Zhang and Xiang 2017). For example, Green discusses the need to introduce new materials into the market faster and at lower costs based on the Materials Genome Initiative. This need is stymied by the lack of effective high throughput experimentation tools. In particular, there is lack of high throughput tools that can automatically and rapidly interrogate a library of samples for the properties of interest. Zhang and Xiang also discuss the long felt need for high throughput tools to measure mechanical properties. They present various microelectromechanical systems (MEMS) tools that can be utilized to measure the mechanical properties of several materials in parallel. However, there is still a dearth of tools that address measuring mechanical properties specifically, and material properties in general, in fluids with high throughput. The systems and method discussed herein fulfill the long-felt yet unmet need for high throughput tools for measuring material properties in fluids. The high throughput approach discussed herein is particularly beneficial in instances where the fluids, such as sol-gel fluids, are tested in microgravity environments, such as in space at e.g., the International Space Station. In such environments, it is important to have tools that provide the ability to measure material properties of a large number of fluids efficiently and reliably. The approach discussed herein can provide high throughput automated readings that require minimal assistance or control by a human.

The challenges associated with a lack of complementary, high-throughput characterization techniques are also compounded by the breadth of structure and property information that could be useful in assessing material performance and quality across different applications (Hoffman 2012, Li and Mooney 2016, Zhang and Khademhosseini 2017). In particular, the characterization of hydrogel viscoelastic properties, as well as of other soft materials, presents significant rate-limiting steps because of the requirement for manual sample preparation steps and the time-intensive nature of the tests. The gold-standard instruments for characterization of hydrogel viscoelastic properties are rheometers and dynamic mechanical analyzers (Brinson and Brinson 2015). While such instruments are robust and provide reliable information regarding the viscoelastic properties of a sample over a range of strain rates and temperatures, the samples must be manually prepared and measured to high tolerances, and experiments can take upwards of 0.5-1 day per sample, depending on the complexity and type of scan being performed. Additionally, such instruments are difficult to integrate with processes, which impedes applications that require viscoelastic property sensing or monitoring. As a result, it remains a pressing challenge to eliminate characterization bottlenecks from accelerated material discovery paradigms. In contrast to traditional characterization methods (e.g., dynamic mechanical analysis (DMA)), sensor-based characterization techniques offer measurement advantages associated with sensors, which include process integration through miniaturization and the ability for real-time process monitoring and control. Sensors can also offer improved sensitivity, limit of detection, throughput, and measurement repeatability relative to traditional methods through the use of sensitive miniaturized transducers and the elimination of manual sample preparation steps. Therefore, sensor-based techniques for characterization of hydrogel viscoelastic properties could provide useful tools for eliminating characterization bottlenecks that currently limit the pace of hydrogel materials research and development.

While various sensors have been created to measure the physical and rheological properties of liquids, (Abu-Zahra 2004, Jain et al. 2001, Jakoby and Vellekoop 2011, Kim 2002) milli- and micro-electromechanical systems have enabled the characterization of viscoelastic properties based on fluid-structure interaction effects (Mather et al. 2012). Thickness shear mode (TSM) resonators, such as quartz crystal microbalances (QCMs), were among the first sensors leveraged for viscoelastic property characterization. While TSM resonators enable the characterization of the viscoelastic properties of semi-infinite and thin layers of viscoelastic liquids, viscoelastic properties are obtained using equivalent circuit models, which imposes the requirement of sensor calibration. In addition to shear-mode resonators, dynamic-mode cantilevers have been extensively examined for sensor-based rheological and compositional analysis of liquids, such as viscosity monitoring, chemical sensing, and biosensing (Craighead 2007, Fritz 2008, Johnson and Mutharasan 2012, Lang et al. 2005, Raiteri et al. 2001, Singamaneni et al. 2008). Analysis of cantilever sensor response can be done using fluid-structure interaction models, which are the same physics that drive the sensor response, in contrast to equivalent circuit models, which are useful for modeling measurements based on impedance responses but are not directly representative of the physical phenomenon. The earliest applications of dynamic-mode cantilevers for characterizing the physical properties of liquids were focused on density monitoring using the well-known inviscid result (Chu 1963). In parallel with liquid density monitoring applications, rheological measurements (i.e., viscosity monitoring) were also performed using cantilever sensors by incorporating the frequency- and mode number-dependent hydrodynamic function. An explicit theoretical relationship between cantilever resonant frequency, quality factor, and the viscosity of the surrounding media has been previously reported (Sader 1998). For example, Chon et al. validated the theoretical results of the cantilever hydrodynamic function using an atomic force microscope (AFM) cantilever submerged in a range of viscous fluids (Chon et al. 2000). Boskovic et al. 2002 demonstrated that an AFM cantilever with a known undamped natural frequency (i.e., resonant frequency) and mass per unit length allowed for the simultaneous calculation of the density and viscosity of both gasses and liquids. Mather et al. extended the use of cantilever sensors for characterization and monitoring of the viscoelastic properties of liquids through the use of mesoscale piezoelectric cantilevers. (Mather, Rides, Allen and Tomlins 2012) In that study, the complex shear modulus was replaced with the viscosity in the previous models developed by Sader, (Sader 1998) Maali et al., (Maali et al. 2005) and Belmiloud et al., (Belmiloud et al. 2006) which yielded a system of equations for the determination of the shear storage and loss moduli of a material from the cantilever resonant frequency and quality factor responses (after accounting for the internal damping of the larger cantilever) (Mather et al. 2012). While Mather et al. were able to characterize the viscoelastic properties of a polyacrylamide solution, fluid damping effects impeded applications to characterization of more viscous or viscoelastic materials. Johnson and Mutharasan 2011 more recently showed that millimeter-scale cantilevers exhibited a sufficiently high cantilever Reynolds numbers to resonate in highly viscous liquids with dynamic viscosities as high as 10³ cP. These studies suggest that millimeter-scale cantilevers could enable sensor-based characterization of solutions that undergo gelation, materials that exhibit sol-gel phase transitions, and the viscoelastic properties of gel-based materials.

As discussed herein, resonance in dynamic-mode cantilever sensors persists in hydrogels and enables the real-time characterization of hydrogel viscoelastic properties and the continuous monitoring of sol-gel phase transitions (i.e., gelation and dissolution processes). Real-time tracking of piezoelectric-excited millimeter cantilever (PEMC) sensor resonant frequency (e.g., fₐᵢᵣ=55.4±8.8 kHz; n=5 sensors) and quality factor (e.g., Q; Qₐᵢᵣ=23.8±1.5) can facilitate continuous monitoring of high-frequency hydrogel shear storage and loss moduli (G′f and G″f, respectively) calculated by sensor data and fluid-structure interaction models. Changes in the sensor phase angle, quality factor, and high-frequency shear moduli obtained at the resonant frequency (G′f and G″f) show strong correlation with low-frequency moduli obtained at 1 Hz using DMA.

Characterization studies were performed using physically and chemically crosslinked hydrogel systems, including gelatin hydrogels (e.g., 6-10 wt %) and alginate hydrogels (e.g., 0.25-0.75 wt %). The sensor exhibits a dynamic range from the rheological properties of inviscid solutions to hydrogels with high-frequency moduli of e.g., 70-90 kPa, or about 80 kPa and low-frequency moduli of e.g., 20-30 kPa or about 26 kPa. In some examples, the sensor can exhibit a limit of detection of 260 Pa and 1.9 kPa for changes in hydrogel storage modulus (E′) based on the sensor's phase angle and quality factor responses, respectively. The sensor data can facilitate quantitative characterization of gelation process dynamics using a modified Hill model. Thus, cantilever sensors provide a promising platform for sensor-based characterization of hydrogels, such as quantification of viscoelastic properties and real-time monitoring of gelation processes.

I: Real-Time Characterization of Hydrogel Viscoelastic Properties and Sol-Gel Phase Transitions Using Cantilever Sensors

1. Materials and Methods

1.1 Materials

Example materials can include Alginic acid sodium salt, gelatin (300 g bloom from porcine skin), poly (ethylene glycol) diacrylate (PEGDA) (750 Da), 2,2-Dimethoxy-2-phenylacetophenone (DMPA), calcium chloride, and EDTA, lead zirconate titanate (PZT-5A; 72.4×72.4×0.127 mm³) with nickel electrodes, borosilicate glass, and ethanol (200 proof). The materials also include Polyurethane (Fast-Drying), epoxy (EA 1C-LV) and cyanoacrylate (409 Super Bonder).

1.2 Fabrication of Piezoelectric-Excited Millimeter Cantilever Sensors

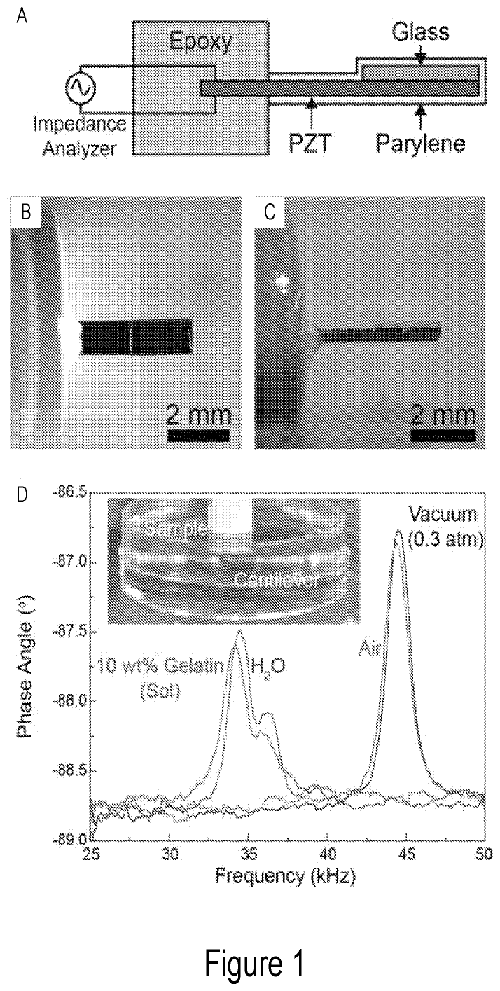

Composite PEMC sensors with a flush design can be fabricated from lead zirconate titanate (PZT) as described in previous studies (e.g., Sharma et al. 2011). FIG. 1A shows an example structure of the PEMC. To manufacture the PEMC, borosilicate and PZT sheets were diced into chips (e.g., 2×1×0.16 mm³ and 5×1×0.127 mm³, respectively). A borosilicate chip was first bonded symmetrically to one end of the cantilever using cyanoacrylate such that the front of both chips are aligned. Subsequently, Cu wires were soldered to the top and bottom faces of the nickel electrodes on the distal end of the PZT layer opposite to the glass layer. The cantilever was then potted in a glass cylinder with a non-conductive epoxy resulting in a cantilever geometry (e.g., 3×1×0.127 mm³). The sensors were then coated with polyurethane via spin coating (e.g., 1000 rpm for 2 min), which was then allowed to cure at room temperature, to improve adhesion of parylene-c to the sensor. The sensors were then coated with parylene-c (e.g., 10 μm thick) following vendor protocols. Following parylene-c coating, the sensors were annealed for 1 hour at 75° C.

1.3 Measurement Principle and Data Acquisition

The sensor resonant frequency (fₙ), quality factor (Qₙ), and phase angle at resonance (ϕₙ), where n indicates the mode number, were continuously monitored with a vector-network analyzer with impedance option (e.g., E5061b-005; Keysight). The sensor's dynamical mechanical response, here, the frequency response, was obtained via electromechanical coupling effects using electrical impedance analysis, which provides electrical impedance magnitude (|Z|) and phase angle (ϕ) spectra of the piezoelectric layer (|Z| and ϕ vs. frequency (f), respectively). While the absolute amplitude of the cantilever vibration could not be determined without additional measurement instrumentation (e.g., associated with optical techniques for deflection measurement), which are challenging in hydrogels, the phase angle of the sensor's electrical circuit at resonance (ϕ=tan⁻¹(ΔV/I)) provides a measure of the relative displacement in the piezoelectric layer and an indirect measure of cantilever amplitude. Thus, the technique is useful for resonant frequency and quality factor tracking in applications that require analysis in complex fluids and materials that may present challenges to the use of optical techniques. Electrical impedance analysis was performed using a stimulus amplitude of e.g., 100 mV AC and zero DC bias across a frequency range (e.g., fₙ−10 kHz fₙ fₙ+10 kHz), which enabled resolution of the off-resonance impedance response and, thus, measurement of the frequency-width-at-half-maximum (FWHM). Sensor signals (fₙ, ϕₙ, FWHM, and Qₙ=fₙ/FWHM) were acquired using a custom MATLAB program based on continuous monitoring of electrical impedance spectra.

1.4 Hydrogel Preparation

Alginate solutions with various concentrations (e.g., 0.25, 0.5, 0.75, 1, 1.5, and 2.0 wt %) were prepared by dissolving alginic acid sodium salt in deionized water (DIW) at room temperature with continuous stirring. The solutions (e.g., 5 mL) were chemically crosslinked by depositing a droplet (e.g., 500 μL) of saturated calcium chloride on the surface of the polymer solution at a short distance (e.g., approximately 5 mm) from the submerged sensor. Gelatin solutions with various concentrations (e.g., 6, 8, 10, and 12 wt %) were prepared by dissolving gelatin in DIW at 40° C. with continuous stirring. Following dissolution, the solution was maintained at 40° C. until use. PEGDA hydrogels were prepared by dissolving e.g., 1, 2, 3, or 4 g PEGDA in e.g., 18.9, 17.9, 16.9, or 15.9 g of DIW at room temperature, followed by the addition of e.g., 0.1 g of 20 wt % DMPA in ethanol for final solutions containing e.g., 5, 10, 15, and 20 wt % PEGDA with 0.1 wt % DMPA. PEGDA hydrogels were cured with exposure to e.g., 365 nm UV light for 10 minutes (1200 ρW/cm² at 3 inches; UVGL-58).

1.5 Viscoelastic Property Characterization Using Dynamic-Mode Cantilever Sensors

The shear storage and loss moduli of the surrounding material, here hydrogels, at the sensor's resonant frequency (G′_{f} and G″_{f}, respectively) were calculated based on previously established fluid-structure interaction models for resonant cantilevers (see e.g., Belmiloud et al. 2006, Boskovic et al. 2002, Dufour et al. 2012, Maali et al. 2005, Mather et al. 2012, and Sader et al. 1998). The inertial and dissipative components of the drag force on a vibrating cantilever (g₁ and g₂, respectively) can be written in terms of the frequency-dependent viscoelastic moduli (G′ and G′) as: (e.g., Mather et al. 2012)

$${g}_{1} = \frac{π}{2} \frac{{b}_{2} {G}^{″}}{ω} + \frac{π}{4 \sqrt{2}} \sqrt{ρ} b [ ( {b}_{1} - {a}_{2} ) \sqrt{\sqrt{{G}^{′2} + {G}^{″2}} + {G}^{′}} + ( {a}_{2} + {b}_{1} ) \sqrt{\sqrt{{G}^{′2} + {G}^{″2}} - {G}^{′}} ] \qquad ( 1 )$$

$${g}_{2} = \frac{π}{4} {a}_{1} ρ {b}^{2} + \frac{π}{2} {b}_{2} \frac{{G}^{′}}{{ω}^{2}} + \frac{π}{4 \sqrt{2}} \frac{\sqrt{ρ} b}{ω} [ ( {a}_{2} + {b}_{1} ) \sqrt{\sqrt{{G}^{′2} + {G}^{″2}} + {G}^{′}} + ( {a}_{2} - {b}_{1} ) \sqrt{\sqrt{{G}^{′2} + {G}^{″2}} - {G}^{′}} ] \qquad ( 2 )$$

where a₁, a₂, b₁, and b₂ are Maali's parameters (e.g., a₁=1.0553, a₂=3.7997, b₁=3.8018, b₂=2.7364) (Maali et al. 2005), w is the angular frequency (here, taken as ω=2πfₙ), ρ is the density of the surrounding material (e.g., fluid), and b is the cantilever width. The components of the drag force can also be calculated from sensor data (i.e., fₙ and Q) as: (Mather et al. 2012)

$${g}_{1} = \frac{π}{4} ρ {b}^{2} ω ( \frac{\frac{( {m}_{c} + {m}_{A} ) ω}{Q} - {c}_{i}}{ρ {b}^{2} L ω \frac{π}{4}} ) \qquad ( 3 )$$

$${g}_{2} = \frac{π}{4} ρ {b}^{2} ( \frac{4 μ ( \frac{{ω}_{o}^{2}}{{ω}^{2}} - 1 )}{π {b}^{2} ρ} ) \qquad ( 4 )$$

where L is the cantilever length, μ=ρ_{c}bt is the cantilever mass per unit length, ρ_{c} and t are the respective cantilever density and thickness, Q₀ and ω₀ are the respective quality factor and resonant frequency in the absence of fluid damping (i.e., resonating in vacuum with only internal damping effects present), m_{c}=ρ_{c}btL is the cantilever mass, m_{A}=ρπb²LΓ′/4 is the added mass, Γ′ is the real part of the hydrodynamic function, and cᵢ=m_{c}ω₀/Q₀ is the internal damping coefficient. Due to the scale of the cantilevers (e.g., L=3 mm) the internal damping was not negligible and was subtracted from the measured value (as described in the term cᵢ in Equation 3). In calculation of cᵢ, ω₀ and Q₀ were approximated as ω₀˜2πf_{n,air} and Q₀˜Q_{n,air}, which were reasonable assumptions as discussed in the following sections. The hydrodynamic function was approximated using the relation Γ′=a₁+a₂δ/b, where δ=[(2η/(ρω)]^{1/2} is the thickness of the thin viscous layer surrounding the cantilever in which the velocity has dropped by a factor of 1/e, and η is the viscosity of the fluid. The solution to the system of equations formed by Equations (1)-(4) provides the viscoelastic properties of the surrounding material based on cantilever sensor data.

1.6 Real-Time Monitoring of Gelation Processes Using Cantilever Sensors

1.6.1 Gelatin Hydrogels: Prior to all experiments, the sensor impedance spectra were characterized in air to obtain the resonant frequency and quality factor. Experiments began by adding e.g., 5 mL of gelatin solution to a dish (e.g., 35 mm) at 40° C. The gelatin solution was maintained at 40° C. during solution phase studies to prevent gelation. The solution was then cooled to room temperature. Subsequently, the cantilever was submerged in the solution to a depth that brought the top surface of the polymer solution 30 μm above the cantilever's anchor. The sensor data acquisition program was subsequently initiated, which enabled continuous monitoring of the sensor signals as the gelatin solution spontaneously underwent a thermoreversible gelation process.

1.6.2 Alginate Hydrogels: The resonant frequency and quality factor in air f_{n,air} and Qₐᵢᵣ, respectively) were determined as described above. Experiments began by adding 5 mL of room temperature alginate solution to a 35 mm petri dish. The cantilever was then submerged as described in the previous section and data collection was initiated. Following stabilization of the sensor signals, the alginate solutions were chemically crosslinked by manually applying a 500 μL droplet of saturated calcium chloride to the surface of the solution approximately 5 mm from the anchor of the cantilever. Addition of a 500 μL droplet of DIW served as an in situ negative control. Following the stabilization of sensor signals after chemical gelation, the hydrogels were dissolved by applying 3 mL of a 1M aqueous solution of EDTA across the surface of the hydrogel.

1.7 Characterization of Hydrogel Low-frequency Viscoelastic Moduli via Traditional Dynamic Mechanical Analysis Studies

Characterization of hydrogel low-frequency viscoelastic properties was done using a dynamic mechanical analyzer (Q800; TA Instruments). Cylindrical test specimens of alginate and gelatin hydrogels (diameter=12.7 mm and thickness=5 mm) were punched from 5 mm thick hydrogel sheets prepared using the same crosslinking techniques as previously described for the sensor studies. All measurements were acquired by application of a 15 μm periodic displacement at a constant frequency (1 Hz) and 5 mN preload force in the compression mode. Temperature-dependent data for the thermally-responsive gel was acquired under the same conditions using a temperature sweep from 26 to 36° C. at a rate of 0.5° C./min.

1.8 Characterization of Sol-Gel Rheological Properties and Gelation Processes via Traditional Rheology

A rheometer (Discovery DH-2, TA Instruments) was implemented with recessed concentric cylinder geometry. Gelatin solution (8 wt %) was loaded into the test geometry with a 1 mm gap. Testing conditions of 1% strain and 1 Hz were imposed. The sample was held at 40° C. then quenched to 25° C. at a rate of 5° C./min, which mimicked the temperature treatment used in the sensor studies. Data collection began when the sample temperature reached 25° C. and continued for 90 minutes. The time of the gelation process as measured through sensor and rheometer data was normalized by the respective total gelation times. The data was truncated in both sensor and rheometer data to the point where G′ reached 95% of the maximum (G′95) and subsequently normalized by G′95 for comparison.

1.9 Calculation of Limit of Detection

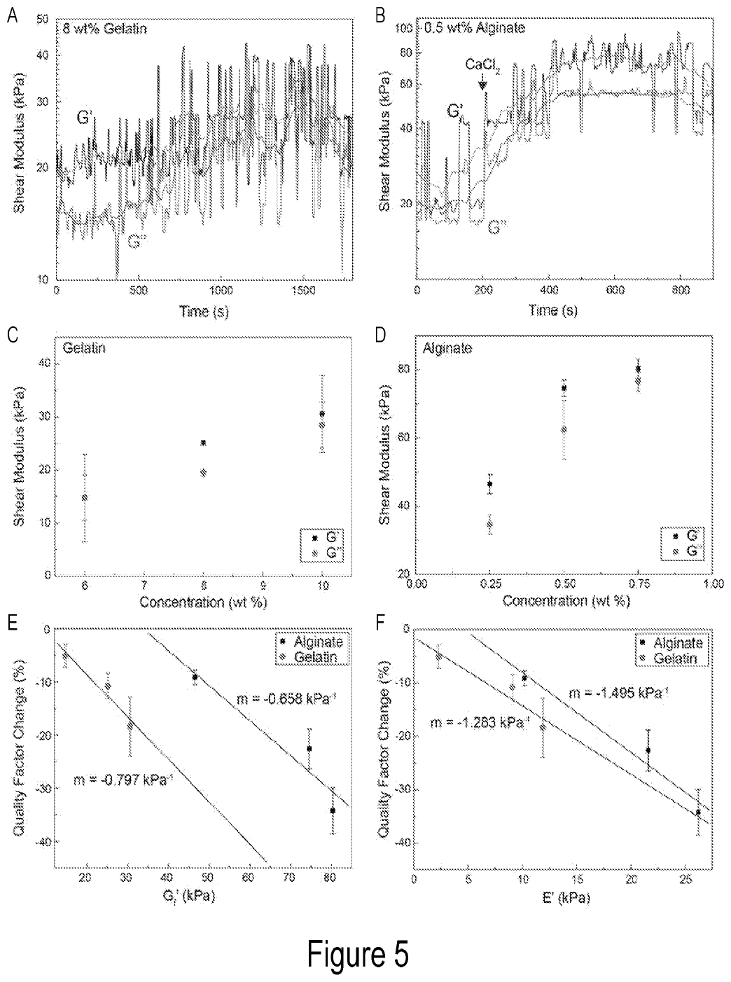

Given that the limit of detection (LOD) is a function of the sensitivity (m) and noise level of the sensor (N), one can use FIGS. 5E and 5F to estimate the sensor's LOD with respect to changes in both G_{f}′ and E′ based on both phase angle and quality factor responses. The following expression can be used to quantify LOD and assumes a signal of a factor of 3.3 times the noise level provides the ability to resolve an associated change in stimulus with sufficient measurement confidence (Allegrini and Olivieri 2014):

$$LOD = \frac{3.3 \times N}{\vert m \vert}$$

As shown in FIG. 5E, the sensitivity for G_{f}′ changes in alginate and gelatin hydrogels based on quality factor response was m=−0.658 and −0.797 kPa⁻¹, respectively. Time series data shows that the noise level associated with the quality factor response in alginate and gelatin hydrogels was N=3.195 and 2.269, respectively (the quality factor is a dimensionless quantity). Thus, the sensor LOD with respect to G_{f}′ changes in gelatin and alginate hydrogels was 13.2 and 11.4 kPa, respectively. As shown in FIG. 5F, the sensitivity for E′ changes in alginate and gelatin hydrogels based on quality factor response was m=−1.495 and −1.283 kPa⁻¹, respectively. Thus, the sensor LOD with respect to G_{f}′ changes in gelatin and alginate hydrogels was 1.9 and 7.1 kPa, respectively. A discussion of the sensitivity and limit of detection associated with phase angle responses is included in Allegrini, F., and Olivieri, A. C., “IUPAC-consistent approach to the limit of detection in partial least-squares calibration,” Analytical chemistry 86, 7858-7866 (2014), which is incorporated by reference herein in its entirety.

2. Results and Discussion

2.1 Characterization of Cantilever Frequency Response in Concentrated Solutions of Gel-Forming Polymers

As shown in FIG. 1A, PEMC sensors are actuated and sensed using the same piezoelectric layer, which is referred to as a self-exciting and self-sensing design. (Itoh et al. 1996) This design enables the sensor's mechanical frequency response to be characterized by the electrical impedance response of the insulated piezoelectric layer (photographs shown in FIGS. 1B-1C). Thus, electrical impedance analysis enables real-time monitoring of the cantilever resonant frequency (fₙ) and quality factor (Qₙ) in various liquids. Having previously shown that resonance in PEMC sensors persists in highly viscous liquids of viscosity up to 10³ cP, (Johnson and Mutharasan 2011) it was examined whether resonance in PEMC sensors persists in solutions of gel-forming polymers and resultant hydrogels. Piezoelectric cantilevers enable mechanical frequency response analysis through an electrical measurement technique, specifically, electrical impedance spectroscopy, which is made possible through the electromechanical coupling effects in the piezoelectric material. Consequently, the amplitude can be monitored indirectly through the phase angle of the electrical circuit formed by the sensor materials and equivalent circuit effects of dynamic motion. As shown in FIG. 1D, the resonance of PEMC sensors is minimally damped by air (f_{n,vac}=44.6 kHz and Q_{n,vac}=24.8 and f_{n,air}=44.4 kHz and Q_{n,air}=24.7). While millimeter-scale piezoelectric cantilevers exhibit a relatively greater amount of internal damping compared to micro-cantilevers, leading to relatively lower quality factors in vacuum, millimeter cantilevers enable resonant frequency tracking in highly dissipative materials. Considering the dimensions and resonant frequency of millimeter-scale cantilever sensors in a highly viscous liquid (width (b)=1 mm; fₙ˜25 kHz), as well as previously reported rheological properties of gel-forming aqueous polymer solutions (η≈200 cP), (Belalia and Djelali 2014) the cantilever Reynolds number (Re_{c}=ρωb²/4η) is ˜150, where ρ is the fluid density, ω=2πfₙ is the angular frequency of the cantilever, and η is the dynamic viscosity of the solution. The result of Re_{c}>1 suggests millimeter-scale cantilever sensors should resonate in concentrated solutions of gel-forming polymers. As shown in FIG. 1D, resonance in PEMC sensors indeed persisted in concentrated solutions of gel-forming polymers (data shown for a 10% gelatin solution).

2.2 Effect of Hydrogel Composition and Low-Frequency Viscoelastic Moduli on Cantilever Frequency Response

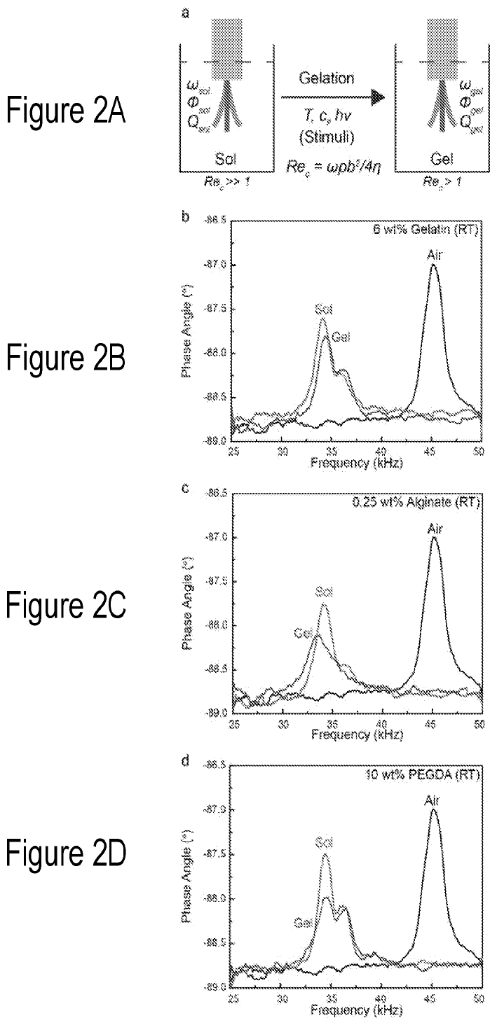

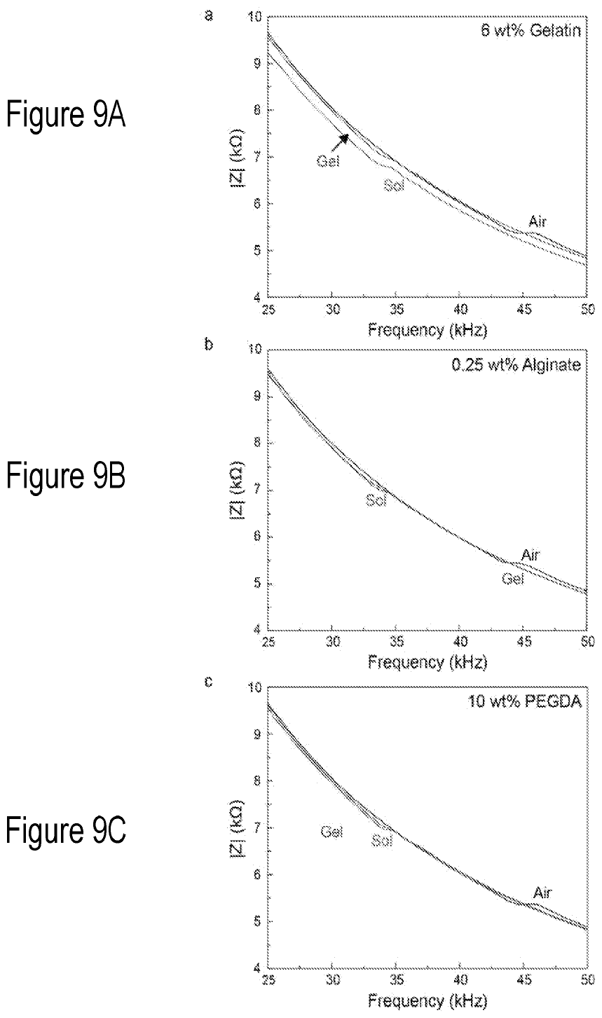

Having established that PEMC sensors resonate in concentrated solutions of gel-forming polymers, it was also examined if resonance persisted in gels following the sol-gel phase transition (see FIG. 2A), as opposed to being absent as a result of increased damping effects of a surrounding gel phase. Studies were conducted using gelatin, alginate, and PEGDA hydrogels based on their extensive use across a range of applications, including tissue engineering, food engineering, and bioprinting applications. As shown in FIGS. 2B-2D, the second mode of cantilever sensors exhibited a resonant frequency of 55.4±8.8 kHz and quality factor of 23.8±1.5 in air (n=5 sensors). The spectral characteristics of the individual sensors are provided in Table 1 below. The second mode was selected because it has previously been shown to persist in high viscosity liquids up to 1,000 cP (Johnson and Mutharasan 2011). These values agreed reasonably with Euler-Bernoulli beam theory and previous finite element studies (Johnson and Mutharasan 2011). The second mode was selected based on its previous use for characterization of high-viscosity liquids (Johnson and Mutharasan 2011). As shown in FIG. 2B, submersion of the sensor in a 6 wt % gelatin solution caused decreases in the cantilever resonant frequency and quality factor to 33.8±0.3 kHz and 17.4±0.1, respectively. As shown in FIGS. 2C and 2D, similar changes in resonant frequency and quality factor were observed upon submersion in 0.25 wt % alginate and 10 wt % PEGDA solutions. The shoulder peak near 36 kHz can be attributed to a torsional mode that is adjacent to the transverse mode used for tracking and rheological characterization. (Johnson et al. 2013) The peak associated with the torsional mode appears absent in air due to its proximity with the bending mode, making it difficult to observe, as it causes a relatively smaller amount of deformation in the piezoelectric layer at resonance. Upon submersion in solution, the torsional mode becomes observable due to the differences in each mode's sensitivity to fluid mass loading effects. Corresponding impedance magnitude data over the same frequency range is presented in FIGS. 9A-9C. Importantly, as shown in FIGS. 2B-2D, resonance in PEMC sensors persisted in 6 wt % gelatin, 0.25 wt % alginate, and 10 wt % PEGDA hydrogels following crosslinking (i.e., network formation).

TABLE 1
Spectral characteristics of the five cantilever
sensors used in this study in air.

| Sensor | fₙ (kHz) | Qₙ |
|---|---|---|
| 1 | 56.8 | 22.3 |
| 2 | 68.3 | 25.9 |
| 3 | 46.6 | 23.4 |
| 4 | 60.6 | 25.2 |
| 5 | 44.7 | 22.3 |

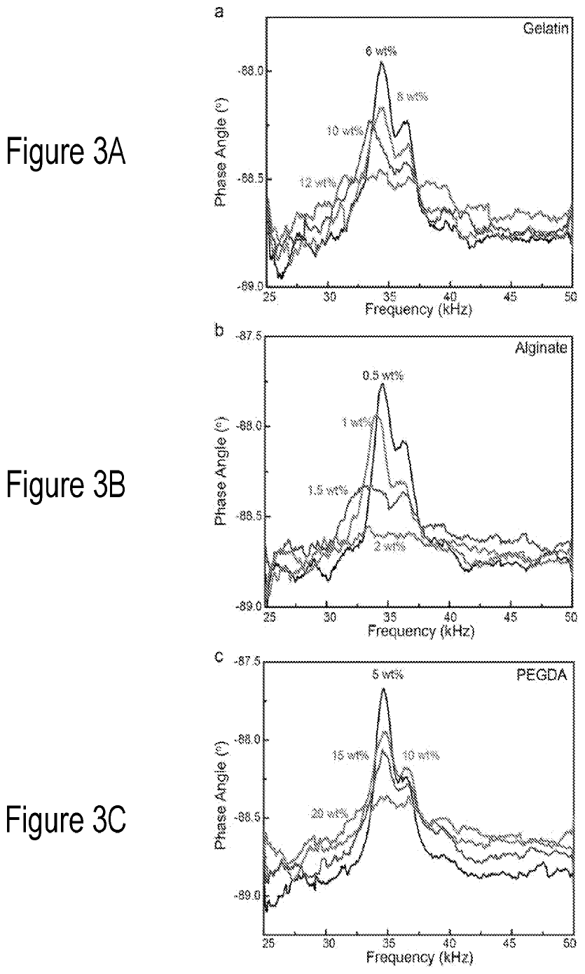

Given that applications may use hydrogels across a range of concentrations, the concentration at which cantilever resonance no longer persisted in the gel phase was also examined (i.e., the concentration at which the cantilever quality factor could not be monitored with suitable resolution for characterization and sensing applications). As shown in FIG. 3A-3C, it is noted that resonance persisted in hydrogels over a wide concentration range from dilute polymer solutions up to 15 wt %. For example, as shown in FIGS. 3A-3C, resonance was observable in gelatin, alginate, and PEGDA hydrogels up to 10, 1.5 and 15 wt %, respectively. These concentrations corresponded to low-frequency storage moduli (E′) of 11.9, 36.2, and 46.2 kPa, respectively, as characterized by traditional DMA studies. Similarly, these concentrations corresponded to complex moduli 0 of 11.9, 37.3, and 47.0 kPa, respectively. This result suggests that the dynamic range and limit of detection regarding sensing of viscoelastic property changes is material dependent. FIGS. 3A-3C also show that while gelation caused a decrease in the sensor quality factor for all hydrogels and concentrations thereof examined, network formation in the polymer solution caused a consistent decrease in the quality factor but had varying effects on the resonant frequency.

Having established that cantilever resonant frequency and quality factor could be measured across a range of concentrations in various hydrogel systems, the low-frequency viscoelastic moduli (E′ and E′) for each hydrogel examined was characterized to establish the sensor's dynamic range regarding low-frequency viscoelastic moduli sensing. As shown in Table 2 below, a positive correlation was observed among the cantilever quality factor (Qₙ) and the low-frequency viscoelastic moduli (E′ and E″). Overall, the data in FIGS. 2A-2D and FIGS. 3A-3D and Table 2 show that resonance in PEMC sensors persists in gelatin, alginate, and PEGDA hydrogels across a range of concentrations that have been used extensively in various applications (Kuo and Ma 2001, Nemir et al. 2010). This suggests that PEMC sensors could be used to characterize the viscoelastic properties of hydrogels based on calibration approaches that involve low-frequency DMA measurements as well as potentially enable real-time sensing of hydrogel viscoelastic property changes by continuous tracking of cantilever resonant frequency, phase angle, and quality factor.

TABLE 2
Comparison among total changes in sensor signals resulting from sol-gel phase
transition of gel-forming polymer solutions with the viscoelastic properties
of the resultant hydrogel acquired using low-frequency DMA studies.

| | PEMC (~35 kHz) | | | DMA (1 Hz) | |
|---|---|---|---|---|---|
| Sample | Δf [%] | Δϕ [%] | ΔQ [%] | E′ [kPa] | E″ [kPa] |
| 6 wt % gelatin | 1.2 ± 0.8 | −0.1 ± 0.1 | −5.1 ± 0.1 | 2.3 | 0.59 |
| 8 wt % gelatin | 1.6 ± 0.3 | −0.1 ± 0.03 | −10.8 ± 2.4 | 9.1 | 0.62 |
| 10 wt % gelatin | 1.5 ± 0.1 | −0.2 ± 0.1 | −18.4 ± 5.0 | 11.9 | 0.64 |
| 0.25 wt % alginate | −0.06 ± 0.01 | −0.3 ± 0.1 | −9.1 ± 1.4 | 10.2 | 2.9 |
| 0.5 wt % alginate | −0.5 ± 0.3 | −0.6 ± 0.1 | −22.6 ± 3.7 | 21.6 | 7.8 |
| 0.75 wt % alginate | −0.6 ± 0.3 | −0.9 ± 0.1 | −34.2 ± 4.3 | 26.2 | 9.1 |

2.3 Real-Time Monitoring of Gelation Processes Using Millimeter Cantilever Sensors

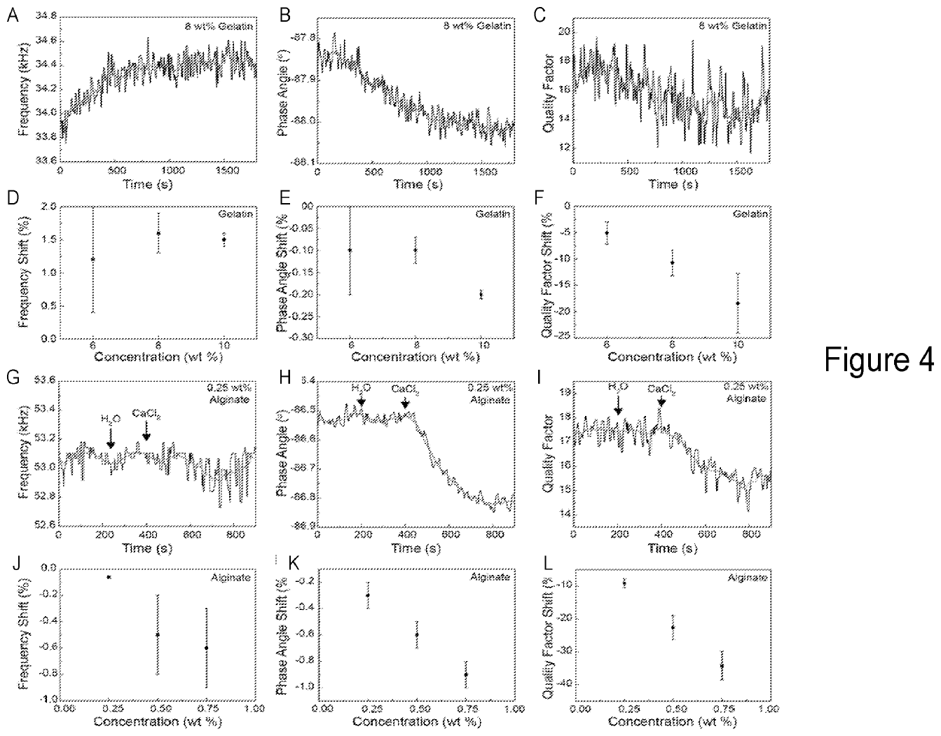

Having demonstrated that resonance in PEMC sensors persists in hydrogels formed through differing chemistry and that changes in sensor quality factor correlated with low-frequency viscoelastic moduli, it was also of interest to determine if PEMC sensors enable real-time monitoring of sol-gel phase transitions via continuous tracking of sensor signals. Gelatin solutions undergo a thermoreversible sol-gel phase transition at room temperature without the addition of a curing stimulus, resulting in a gel. (Djabourov et al. 1988) As shown in FIGS. 4A-4C, gelation of gelatin solutions caused a continuous change in the resonant frequency, phase angle, and quality factor at 6, 8, and 10 wt % over 1,800 s (30 minutes), which is relatively consistent with previously reported gelation times (Fonkwe et al. 2003) (data shown for 8 wt %). At all concentrations examined (6, 8, and 10 wt %), the resonant frequency underwent an immediate increase before stabilizing after approximately t=1,100 s. As shown in Table 2 and FIG. 4A for the case of 8 wt %, gelation of 6, 8, and 10 wt % gelatin solutions caused resonant frequency increases of 1.2±0.8, 1.6±0.3, and 1.5±0.1% (n=3 studies). In contrast to the resonant frequency increase, which was an immediate effect, both the phase angle and quality factor remained relatively stable for the first 400 s, before ultimately decreasing exponentially until stabilizing at t=1,270 and 960 s, respectively, defining the stabilization time as that at which 95% of the final change in sensor signal had been reached. As shown in FIGS. 4D-4F and Table 2, the sensor signals changes upon gelation correlated with the concentration and low-frequency viscoelastic moduli (E′ and E″), of the surrounding hydrogel. As shown in FIG. 4D, the resonant frequency increased by approximately 1 to 1.5% upon gelation at all concentrations. The phase angle decreased by 0.1±0.03 and 0.2±0.1% at 8 and 10 wt % gelatin, respectively (a significant change in phase angle upon gelation of 6 wt % gelatin solutions was not observed) (see FIG. 4E). As shown in FIG. 4F, the quality factor decreased by 5.1±0.1, 10.8±2.4, and 18.4±5.6% at 6, 8, and 10 wt % gelatin, respectively.

Similar to the thermoreversible gelation of gelatin solutions, the chemical gelation of alginate solutions can cause exponential decreases in various sensor signals (see FIGS. 4G-4I). For example, the phase angle and quality factor changed exponentially at all concentrations examined (0.25, 0.5, and 0.75 wt %; see FIGS. 4h-i). The chemical gelation of 0.5 wt % alginate solutions may not cause a significant change in the resonant frequency, but can lead to an increase in the sensor noise level (see FIG. 4G). A summary of the resonant frequency, phase angle, and quality factor changes caused by the chemical gelation of alginate solutions are summarized in FIGS. 4J-4L. Interestingly, while only the quality factor changes correlated with the hydrogel concentration and low-frequency storage modulus across the 6-10 wt % concentration range for the gelatin system (see FIGS. 4D-4F), both phase angle and quality factor changes correlated with the hydrogel concentration and low-frequency storage modulus across the 0.25-0.75 wt % concentration range for the alginate system. For example, the phase angle decreased by 0.3±0.1, 0.6±0.1 and 0.9±0.1% as a result of hydrogel crosslinking for 0.25, 0.5, and 0.75 wt % alginate, respectively (see FIG. 4h). As shown in FIG. 4I, the quality factor decreased by 9.1±1.4, 22.6±3.7, and 34.2±4.3% during the crosslinking process for 0.25, 0.5, and 0.75 wt % alginate, respectively. The total resonant frequency changes were not significant relative to the signal noise level at all concentrations.

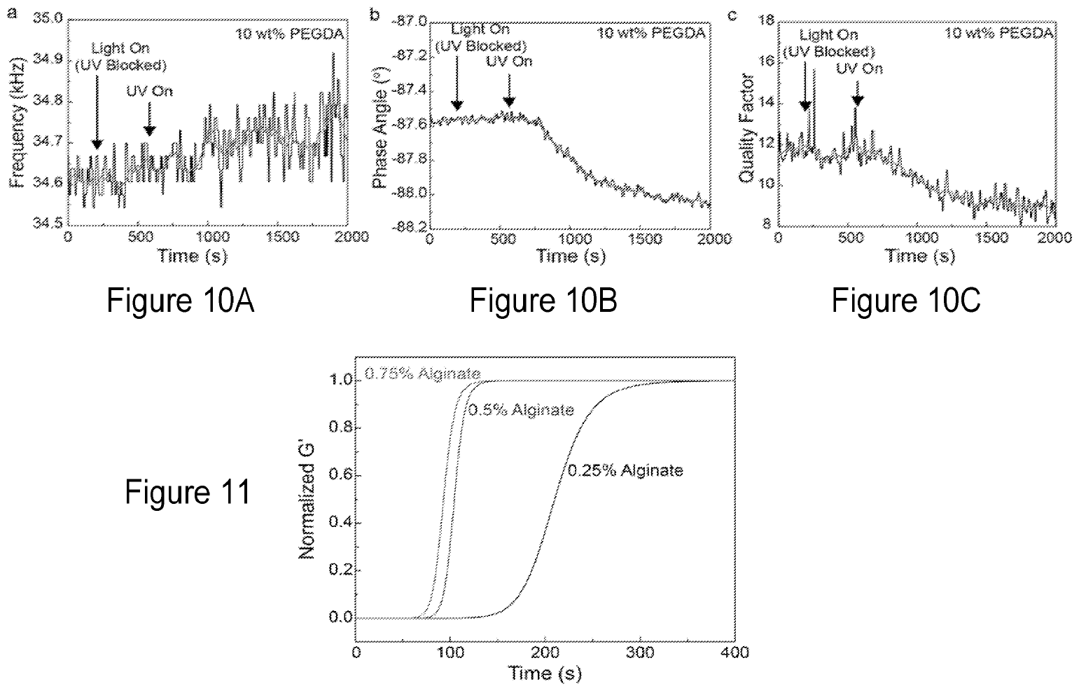

These collective results from the gelatin and alginate hydrogel systems show that in addition to enabling real-time monitoring of the gelation process using resonant frequency, phase angle, and quality factor responses, the sensor responses (specifically, the phase angle and quality factor) enabled the quantification of hydrogel polymer content (i.e., concentration) and low-frequency viscoelastic properties across a wide dynamic range through a calibration approach (i.e., a set of offline DMA measurements taken on experimental standards). Sensor data associated with real-time monitoring of photo-gelation processes is provided in FIGS. 10A-10C for the PEGDA system. The correlations between phase angle and quality factor changes with hydrogel composition and low-frequency viscoelastic properties found in the gelatin, alginate, and PEGDA hydrogels suggest that millimeter cantilever sensors provide useful signals for real-time monitoring of gelation processes and rheological characterization of sol-gel systems.

### 2.4 Quantification of Hydrogel High-Frequency Viscoelastic Moduli Using Sensor Data

Having established a sensor-based approach for characterization of sol-gel phase transitions and low-frequency hydrogel viscoelastic properties based on benchmarking (i.e., calibration) of total changes in sensor signals with offline DMA data acquired using traditional techniques, a cantilever fluid-structure interaction model can be used for viscoelastic materials (Equations (1)-(4)) to examine the behavior of the high-frequency storage and loss moduli obtained at the resonant frequency (G_{f}′ and G_{f}″, respectively) and understand their correlation with low-frequency moduli (E′ and E″). In other words, this approach can establish the relationship between low-frequency (1 Hz) viscoelastic moduli obtained using traditional characterization platforms (e.g., DMA) and high-frequency viscoelastic moduli (˜35 kHz) obtained using PEMC sensors. FIGS. 5A and 5B show the representative trends in G_{f}′ and G_{f}″ during gelation for both the gelatin and alginate systems (data shown for 8 and 0.5 wt %, respectively). Both G_{f}′ and G_{f}″ increased throughout the gelation process, as was observed with low-frequency viscoelastic moduli (Bonino et al. 2011). However, there was not a crossover point between G_{f}′ and G_{f}″, which is typically associated with low-frequency gelation rheology and has been previously reported for gelation of gelatin (Tosh and Marangoni 2004) and alginate hydrogels (Bonino, Samorezov, Jeon, Alsberg and Khan 2011). Regarding the relative magnitudes of G_{f}′ and G_{f}″, it is not unreasonable for G′ to be greater than G″ at high frequencies, even in the solution phase due to the relatively slow relaxation time of long biopolymer solutions. (Janmey et al. 2007)

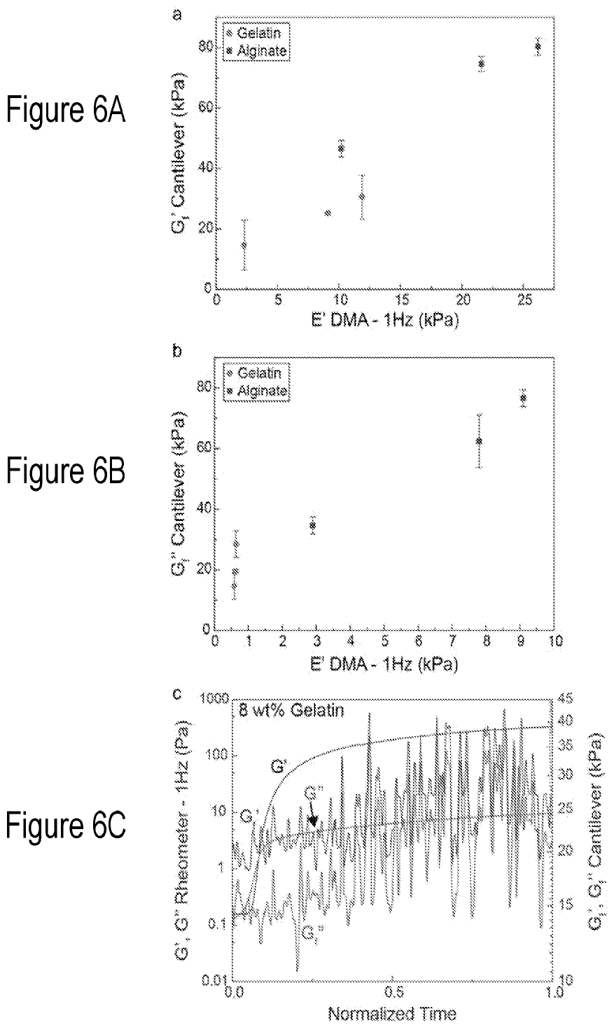

As shown in FIG. 5C, the shear storage moduli of gelatin hydrogels at the resonant frequency (G_{f}′) were 15±8, 25±0.4, and 31±7 kPa and the shear loss moduli (G_{f}″) were 14±4, 20±0.7, and 28±4 kPa for 6, 8, and 10 wt %, respectively. These values are of the same order of magnitude as previously reported values obtained using traditional low-frequency rheological techniques (0.1-10 Hz)(Ahmed 2017, Simon et al. 2003). For example, Simon et al found that porcine gelatin exhibited shear storage moduli ranging from 3.2 to 13 kPa over the range 5 to 12 w/v % at 1 Hz (Simon, Grohens, Vandanjon, Bourseau, Balnois and Levesque 2003). For the case of alginate hydrogels, G_{f}′ were 47±3, 75±2, and 80±3 kPa and G_{f}″ were 35±3, 62±9, and 77±3 kPa for 0.25, 0.5, and 0.75 wt %, respectively (see FIG. 5D). Similar to the characterization of gelatin hydrogels, these values are of the same order of magnitude as previously reported values obtained using traditional low-frequency rheological techniques (Duan et al. 2017). Duan et al found that 2 w/v % alginate exhibited shear storage and loss moduli of 21.1 and 3.4 kPa at 1 Hz. The fact that G_{f}′ and G_{f}″ obtained from sensor data were larger than E′ and E″ obtained from DMA is consistent with the frequency response of dynamic moduli, which typically increase with increasing frequency (Brinson and Brinson 2015). It should be noted that while storage modulus of a stable system increases with frequency, this is not the case for loss modulus. Thus, the relative increase in moduli is not unexpected when considering the magnitude of the resonant frequency of the sensor (˜35 kHz; see FIG. 2). The limit of detection for changes of G_{f}′ in gelatin and alginate hydrogels based on sensor quality factor response was 13.2 and 11.4 kPa, respectively (see the associated Q-G_{f}′ sensor transfer function in FIG. 5E). The limit of detection for changes of E′ in gelatin and alginate hydrogels based on sensor quality factor response was 1.9 and 7.1 kPa (see Table 2 and FIG. 5F). The data in FIG. 4K can also be used to determine the sensor limit of detection based on phase angle response. Based on the DMA results and data in FIG. 4K, the limit of detection in alginate based on phase angle data was about 260 Pa. This greater sensitivity can be attributed to a lower noise level in the phase response data. As shown in FIGS. 6A and 6B, the shear moduli obtained at resonance (G_{f}′ and G_{f}″) exhibited a positive correlation with the low-frequency storage modulus (E′) acquired with DMA. While G_{f}″ exhibited a positive correlation with alginate hydrogels, the gelatin hydrogel system exhibited limited correlation. This relationship is likely dependent on the hydrogel's Poisson's ratio and material property frequency dependence (Brinson and Brinson 2015). These results suggest that real-time monitoring of high-frequency viscoelastic moduli using sensor-based approaches provides a promising technique for characterization of gelation dynamics and quantification of hydrogel viscoelastic properties over a wide frequency range (Hz-kHz).

In addition to correlation between high- and low-frequency viscoelastic properties in cured hydrogels obtained using sensor-based approaches and traditional platforms, the high- and low-frequency shear moduli exhibited similar temporal responses throughout the gelation process (see FIG. 6C). The time at which the temperature of the gelatin solution reached room temperature after quenching from the solution phase at 40° C. was taken as the time t=0 in study. The time scales were normalized by the time at which G′ reached 95% of the total change. It should be noted that the traditional rheology data (1 Hz) exhibits a crossover in G′ and G″ at t=0.08, while G_{f}′ was greater than G_{f}″ for the duration of the experiment based on the cantilever data (34 kHz). While there is no crossover point to indicate a specific gelation time in the PEMC data, it is apparent that the increase in moduli occurred at a relatively later time than in the traditional rheology data. This could be due to the documented effect of increasing shear rate slowing gelatin gelation due to the effects on network formation (de Carvalho and Djabourov 1997). As shown by de Carvalho et al., increasing the shear rate from 1 to 1000 Hz not only delayed the onset of moduli increase (often referred to as phase II of gelation) but also depressed the slope of the increase in moduli (de Carvalho and Djabourov 1997) similar to the data collected using the PEMC sensors. Strain magnitude may also contribute to changes in gelation processes relative to those occurring in the presence of static solid boundaries. For reference, the PEMC sensor data shown here were collected at the cantilever resonant frequency.

2.5 Modeling of Gelation Process Dynamics Using Sensor Data

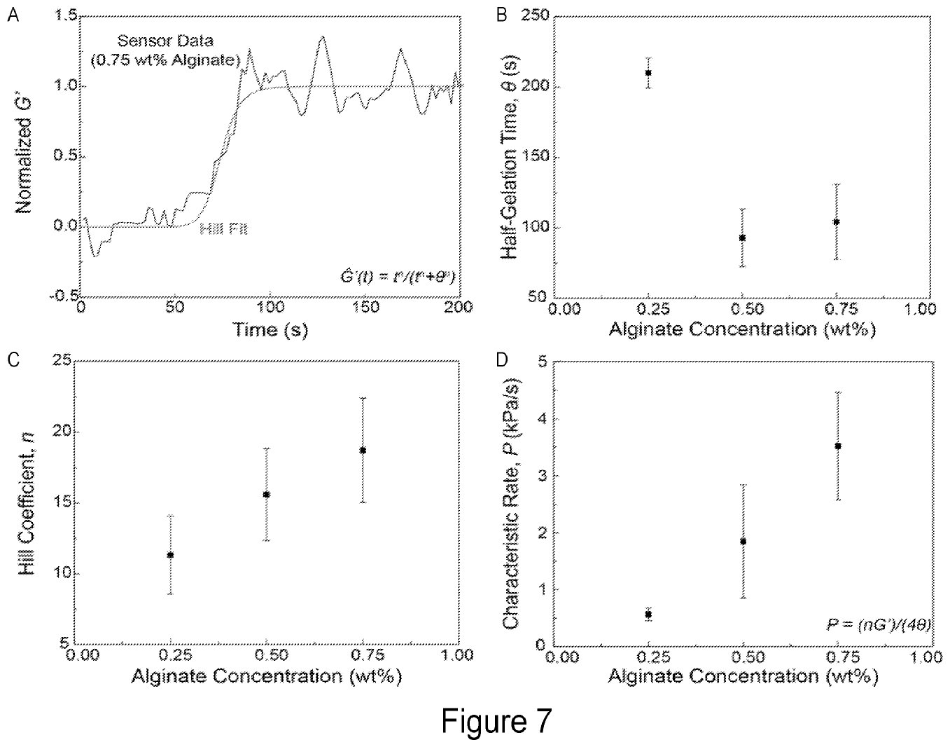

Given the previous sections establish that PEMC sensors enable characterization of low- and high-frequency viscoelastic properties and real-time monitoring of gelation processes, the following examines if sensor data could be leveraged to model the dynamics of gelation processes. Sensor responses to chemical gelation of alginate solutions were analyzed using a modified Hill equation based on its previous use in modeling of gelation processes that were characterized using traditional rheological techniques and is given as: (Calvet et al. 2004, Hill 1913)

$${\hat{G}}^{′} ( t ) = \frac{{t}^{n}}{{t}^{n} + {θ}^{n}} \qquad ( 5 )$$

where Ĝ′ is the normalized storage modulus, t is time, n is the Hill coefficient, and θ is the half-gelation time determined by the time at which G′, and thus, has reached 50% of the total change. The modified Hill equation can also be used to calculate a characteristic gelation rate (P) as:

$$P = \frac{{nG}_{gel}^{′}}{4 θ} \qquad ( 6 )$$

where G′_{gel} is the storage modulus of the final gel. As shown in FIG. 7A, the modified Hill model exhibited a reasonable fit to the sensor data (shown for chemical gelation of 0.75 wt % alginate solutions). Additional analyses of 0.25, 0.5, and 0.75 wt % alginate hydrogels are shown in FIG. 11. The initial time point (t=0) was taken as the time at which the crosslinking agent was applied to the alginate solution. The dependence of the half-gelation time on hydrogel concentration is shown in FIG. 7B. Chemical gelation of the 0.25 wt % alginate solution exhibited the longest half-gelation time of 210±11 s compared to 93±20 and 104±27 s for 0.5 and 0.75 wt % alginate, respectively. There was no significant difference in the half-gelation time between 0.5 and 0.75 wt % alginate. As shown in FIG. 7C, the Hill coefficient and the characteristic gelation rate increased with increasing alginate concentration. The characteristic gelation rates were 564±114, 1844±934, and 3516±944 Pa/s for 0.25, 0.5, and 0.75 wt % alginate, respectively. The characteristic gelation rate obtained via sensor responses during alginate gelation was higher than previously reported values. (Harini and Deshpande 2009, Junior et al. 2019) Junior et al. found a characteristic rate of P=46.8 Pa/s for the chemical gelation of 2 wt % alginate hydrogels (Junior, Davila and d'Avila 2019). The significant increase in the P values extracted here may be largely attributed to the significantly higher final storage modulus measured using resonant PEMC sensors in this study. For example, multiplying the characteristic rate determined using sensor data for 0.75 wt % alginate (P=3516 Pa/s) by the ratio of the low-frequency modulus measured by Junior et al. to the high-frequency modulus measured here (G′/G_{f}′=0.92 kPa/80 kPa) yields a calibrated characteristic rate of 40.4 Pa/s, which agrees well with the results of previous studies (Junior, Davila and d'Avila 2019). These results indicate that in addition to providing quantitative characterization of hydrogel viscoelastic moduli and real-time monitoring of gelation processes, the sensor responses associated with gelation processes can be used for quantitative characterization of gelation process dynamics.

2.6 Real-Time Monitoring of Hydrogel Dissolution Processes

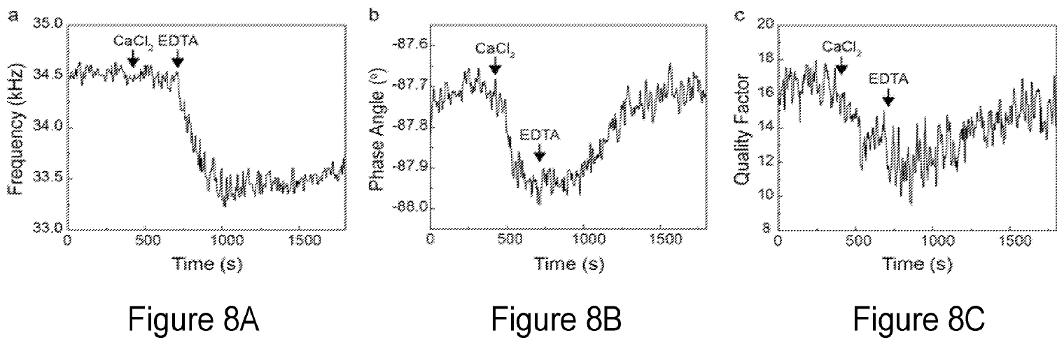

To further evaluate the utility of the sensor for future applications in viscoelastic characterization of hydrogels and continuous monitoring of gelation processes, the following further examines the real-time monitoring of hydrogel dissolution processes. As shown in FIGS. 8A-8C, the application of 3 mL of 1M EDTA chelating solution following chemical gelation of alginate solutions led to a recovery in the phase angle and quality factor, which is consistent with hydrogel dissolution. EDTA is a well-established chelating agent that is capable of dissolving alginate hydrogels based on its affinity for calcium cations that cause the chemical gelation of alginate solutions. (Boontheekul et al. 2005) Interestingly, the application of the dissolving agent results in a decrease in resonant frequency (see FIG. 8A; n=3 repeated studies), which could be attributed to a mass-change response associated with EDTA uptake by the surrounding material. Previous studies that examined the adsorption of metal-EDTA complexes on various surfaces also suggest that EDTA and calcium-EDTA complexes may also adsorb to the sensor surface (Nowack and Sigg 1996). While the phase angle returned to the original value after the dissolution process (see FIG. 8B), the quality factor did not fully recover (see FIG. 8C), which may be attributed to a mass-damping effect associated with the observed resonant frequency decreases or differences in the rheological properties of the initial and final solutions. These results support the fact that cantilever sensors can assess a range of sol-gel transition processes, which are of use for characterizing hydrogels across a wide range of applications. The observed change in resonant frequency also suggests that considerations of chemical binding to the sensors during rheological studies, such as binding of polymer or crosslinking agents, may be important for accurate quantification of rheological properties based on sensor data.

Thus, resonance in cantilever sensors persists in hydrogels. This result enables the characterization of low- and high-frequency hydrogel viscoelastic properties and the real-time monitoring of sol-gel phase transitions (i.e., gelation processes). Studies were performed on various hydrogel systems that underwent thermoreversible-, chemical-, and photo-gelation processes. Changes in the sensor phase angle, quality factor, and high-frequency shear moduli obtained at the resonant frequency (G′_{f} and G″_{f}) correlated with low-frequency moduli obtained using traditional DMA and rheology platforms. These results suggest that real-time monitoring of high-frequency viscoelastic moduli using sensor-based approaches provides a promising technique for characterization of gelation dynamics and quantification of viscoelastic properties of hydrogels over a wide frequency range (Hz-kHz). This work also suggests that cantilever sensors could provide a promising platform for sensor-based characterization of hydrogels that may lead to future breakthroughs in process control and high-throughput characterization. In addition, resonance and quality factor tracking in millimeter-scale cantilever sensors appears to provide an attractive integrated characterization and bioanalytical platform for gel-based biomanufactured products, such as molded or 3D bioprinted hydrogel-based tissues, via real-time detection of rheological property changes, chemical sensing, and bio-sensing.

II. Automated High-Throughput Characterization of Viscoelastic Properties and Sol-Gel Phase Transition Diagrams

Materials: As discussed herein, the phase transition behavior and viscoelastic properties of multiple thermoreversible hydrogels based on both synthetic and natural polymers is introduced. This includes hydrogels of Pluronic 127 (molecular weight (MW)=e.g., 12.6 kDa), polyvinyl alcohol (e.g., Pₙ=500), gelatin (e.g., MW=50-100 kDa, from porcine skin), and methylcellulose (e.g., 4,000 cP at 20° C.). Polymer solutions can be prepared in deionized water (e.g., 18 MQ, Milli-Q System, Millipore). The hydrogels were selected based on their broad utility among a wide range of applications, including engineered tissues, foods, pharmaceuticals, and devices, and because their phase-transition behavior has been previously characterized using alternative low-throughput approaches (see references AMD 2019, Ohkura et al. 1992, Choi et al. 2001, Shibatani et al. 1970, Tanaka et al. 1979, Parker et al. 2012, Bansil et al. 1992, Sanwlani et al. 2011, Takahashi et al. 2001, and Arvidson et al. 2013). Thus, they provide excellent choices for benchmarking the data generated by the new sensor-based HTC platform.

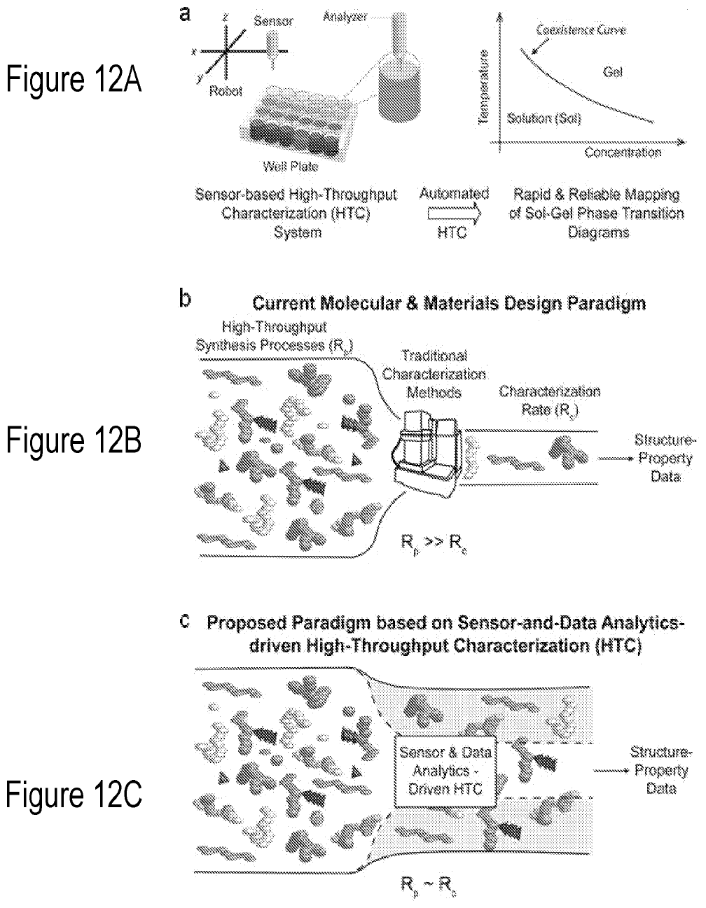

Sensor-based HTC Platform for Terrestrial Environments: As shown in FIG. 12A, the ground version of the sensor-based HTC platform consists of a three-axis robot, stage, heated/cooled plate holder, and cantilever sensor enclosed in a sealed chamber. The platform also has an external motion controller, temperature controller, impedance analyzer, and two computers.

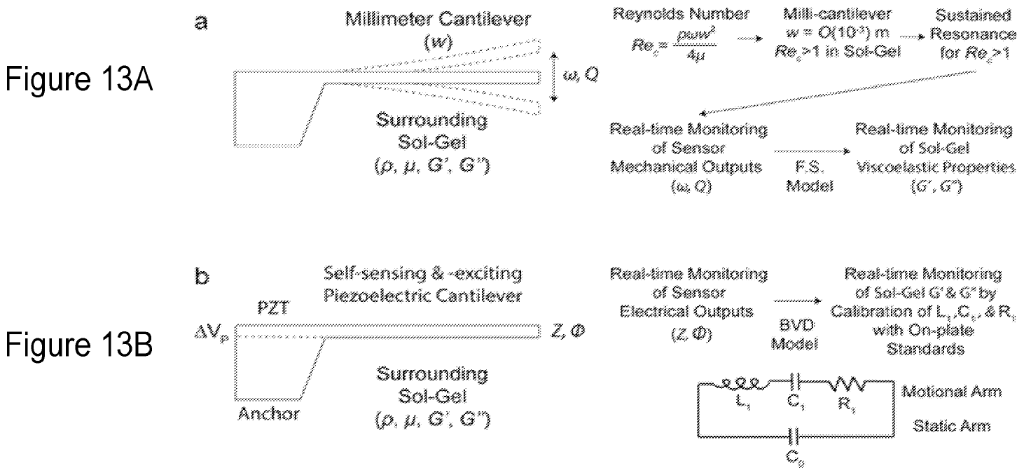

Hardware: Robot: The HTC platform is based on a three-axis robot structure (e.g., MPS50SL; Aerotech, however any other robotic structure that is capable of positioning the sensor in a three-dimensional space can be used), a digital, a motion controller (e.g., A3200; Aerotech), and a dedicated desktop computer. Stage: Plates are placed on a four-leg mechanical stage that enables manual leveling (e.g., Thorlabs). Leveling can achieved using a 1D laser displacement sensor (e.g., IL-1000; Keyence). A closed-loop controlled thermoelectric cooling module affixed on top of the stage enables heating and cooling of the well plate from 5-80° C. An integrated thermistor and infrared camera ensure temperature sensing on the plate. These components are integrated with a sealed chamber to control disturbances, such as heat transfer caused by natural convection. The chamber can be manually opened by the user to insert and remove well plates. The stage also contains a custom clamping system for well plate anchoring during the measurement to eliminate any potential movement of the plate during measurement and maintain mechanical contact between the bottom of the plate and the thermoelectric cooler. Sensor: Piezoelectric-excited millimeter cantilever (PEMC) sensors with asymmetric anchoring are fabricated from lead zirconate titanate (PZT) chips (5×1×0.127 mm³). Details of fabrication are discussed in references [39]-[45]. Briefly, 30-gauge copper (Cu) wires are soldered to the top and bottom thin-film nickel electrodes at the end of the PZT chip. The chip is then embedded in a 6 mm diameter glass tube with a non-conductive epoxy. Anchor asymmetry is obtained by applying additional epoxy to one side of the cantilever extending from the embedded end. The sensors are then spin-coated with polyurethane (˜30 μm). Subsequently, the sensors are insulated by a chemical vapor deposited parylene-c coating (10 μm) in batches of 25-50 sensors following vendor-supplied protocols (PDS 2010 Labcoter® 2, Specialty Coating Systems, Indianapolis, IN). Data is acquired using an impedance analyzer (E5061B; Keysight). The self-sensing and -exciting design of the PEMC sensor facilitates robust monitoring of gel-based materials analysis (e.g., viscoelastic properties) due to the sensor's flow regime as indicated by a cantilever Reynolds Number (Re_{c}>1) (See, e.g., references Johnson et al. 2011, Looker et al. 2008, and Van Eysden et al. 2009). The sensor also supports dual transduction of viscoelastic property changes through both dynamic mechanical and electromechanical effects (see e.g., FIGS. 13A and 13B, respectively).

Experimental Studies: The following terrestrial experimental studies are performed to understand the effect of microgravity on sol-gel phase transition behavior of hydrogels and the high-frequency viscoelastic properties of hydrogels formed in microgravity.

Path Planning for Automated Sensor-based Rheological Property Characterization in Well-Plate Formats: The sensor's path across the well plate, known as the tool path, is defined in terms of robot motion commands using G code. The sensor path is based on a repeated dwell-dip-dwell-move loop that occurs in each well. Measurement of rheological properties occurs during the dwell phase. The measurement occurs at a fixed temperature. The starting temperature is chosen such that the sol-gel system is in the solution phase (5° C. in the Pluronic-F127, polyvinyl alcohol, and methylcellulose hydrogels and 60° C. for the gelatin hydrogels). The sensor path trajectory is in the direction of increasing well number, and here, increasing concentration based on the plate preparation protocol, which is described further in the following section. The stabilization time in air before the dip command is one minute. The dip motion command results in full submersion of the sensor in the material. The second dwell command has a duration of three minutes during which the rheological properties of the material are obtained. A feed rate of 1 mm/s is used for all motion commands to reduce the potential for robot motion to cause vibration of the robot or plate holder and has been verified through our proof-of-concept studies. The measurement is repeated at successively higher or lower temperatures based on the starting temperature using a temperature increment of 3° C. across the 5-60° C. temperature range. The plate lid is closed during all heating and cooling cycles to mitigate the formation of temperature gradients in the well. Sensor data acquisition begins one hour before initiating the previously described tool path to allow the sensor signals to reach a steady state. Sensor data is continuously collected throughout the tool path.

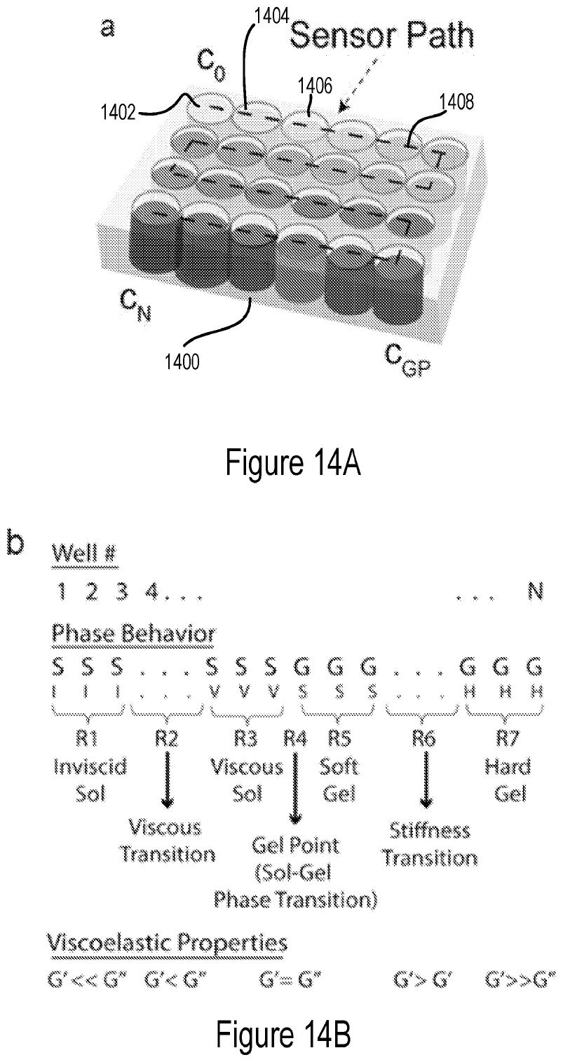

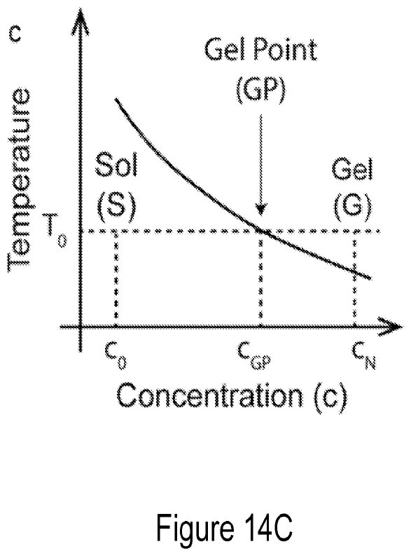

Plate Preparation Protocol: The material systems are prepared in 96-well plates. Sol-gel systems are prepared in the solution phase and mixed for three minutes (ARE-310; Thinky) prior to plate filling to ensure the presence of a homogeneous phase. Following preparation, the mixtures are successively dispensed in the individual wells of the 96-well plate in the order of increasing concentration (see FIG. 14A). Concentration step sizes of 0.5-2 wt % are examined. On-plate calibration standards (i.e., negative and positive controls) are included, as typically done for enzyme-linked immunosorbent assay (ELISA)—a gold-standard well plate-based bioanalytical technique. Controls: Eight wells are filled with water and eight wells are filled with glycerol to provide negative controls of inviscid and viscous solutions, respectively, and establish a baseline for the measurements with the sol-gel systems. Eight wells are also filled with Pluronic F127-water mixtures that range from 5-30 wt % w/w, which spans the gel point across the experimental temperature range. Sample Sizes: Based on an expected normalized standard deviation of −0.15 (equivalent to a signal-to-noise ratio greater than 10 for each sensor signal), a power-law calculation (See e.g., references Clauset et al. 2009, and Charan et al. 2013) suggests a sample size of nine is adequate to achieve a 95% confidence interval. Thus, for each of the four plates (i.e., hydrogel systems), the measurement is repeated nine times. Considering each well plate is filled with up to 72 samples of varying concentrations that span the gel point (recall there are 24 controls per plate), this study involves the automated characterization of 72*4*9=2,592 samples. The low-frequency viscoelastic properties of the hydrogels (1-10 Hz) are acquired using DMA (Q800; TA Instruments). However, this is only done for gels formed at high concentration due to the throughput limitations. Rationale: Water and glycerol are selected as on-plate negative controls based on their use as sensor calibration standards in previous publication (see e.g., reference Johnson et al. 2011). The on-plate water controls also provide the ability to clean the sensor if required. The Pluronic F127-water system serves as a positive control based on our proof-of-concept studies with the HTC platform in terrestrial environments and access to previously reported phase transition behavior (see e.g., reference Gioffredia et al. 2016). All measurements are made in 96-well plates based on the well dimensions, which have been shown to retain solutions in microgravity due to surface tension effects (See e.g., references Sambandam et al. 2014, Nislow et al. 2015, Sharma et al. 2008, and Snell et al. 2001). The proposed tool path and plate layout generate a data structure (see FIG. 14B) that enables automated HTC of sol-gel phase transition diagrams (see FIG. 14C). The well plate 1400 can include any number of wells, such as for example between about 2 wells to about a few thousand wells, and may be limited for example, by the of the robotic structure's ability to traverse the well plate dimensions.

The wells C₀ to C_{N} can be arranged in rows and columns as shown in FIG. 14A, however, any arrangement can be used, as long as the relative positions of each well can be derived from an initial position of the sensor. The well plate 1400 can include a first well 1402, a second well 1404, a third well 1406, and so on. The robotic structure maneuver the sensor over a sensor path 1408 which first traverses all the wells in a first row (e.g., of 6 wells), then the second row, until finally the last well C_{N} is reached. The sensor path 1408 is only an example, and various implementations can have various paths. For example, an alternative sensor path 1408 can be the one which starts from the top right corner well as the first well, and moves down along the rightmost column first. In some examples, the sensor path can be based on the washing requirement of the sensor, and can include moving the sensor to a well that includes a washing fluid such as, for example, water, to wash the sensor and then moving the sensor back to the next well. The robotic structure can move the sensor over a well in the sensor path, and then lower the sensor into the well such that the sensor is immersed into the sample. A data acquisition system, such as an impedance analyzer, can continue to take readings from the sensor during the motion of the sensor over the sensor path 1408. A controller can control and communicate with robotic structure as well as the data acquisition system, such that eth controller can analyze the data captured by the data acquisition system and based on the analysis control the robotic system to appropriately position the sensor.

Data Acquisition: Sensor data is acquired as described in our previous reports (see e.g., references Mutharasan et al. 2010, Johnson et al. 2011, Sharma et al. 2011, Johnson et al. 2011, Johnson et al. J. Micromech. Microeng, 2011, Johnson et al. Anal. Chem., 2013, and Johnson et al. Analyst, 2013). The sensor impedance and phase angle frequency responses are continuously monitored across a frequency range of ±10 kHz centered on the resonant frequency using a network analyzer (E5061B; Keysight). This approach enables continuous monitoring of the sensor's mechanical and electrical outputs using a dedicated computer, including the resonant frequency (fₙ=ωₙ/2π), quality factor (Q=fₙ/frequency-width-at-half-maximum (FWHM)), impedance at resonance, and phase angle at resonance (see FIGS. 13A-13B for details regarding the sensor transduction principle). Matlab provides real-time data acquisition.

Data Analysis and Interpretation: As described in the Data Acquisition Section, Matlab provides real-time monitoring of the sensor signals. As shown in FIG. 13A-13B, the sensor outputs enable quantification of the material rheological properties. Thus, Matlab is also used to calculate the viscoelastic properties of the material in each well from (1) first principles using a fluid-structure interaction model⁵⁶ and (2) on-plate calibration standards using a modified-BVD model (see e.g., reference Arnau et al. 2001). The onset of an added-mass response and storage modulus increase at the resonant frequency is interpreted as the gel point based on our proof-of-concept studies, which are discussed further in the following discussions. The gelation concentration, identified by the concentration at which gelation occurs, vs. temperature data is leveraged in the following tasks for modeling of the sol-gel phase transition thermodynamics (see FIG. 14C).

Risk Mitigation—Potential Pitfalls and Alternative Options: Although not observed in our proof-of-concept studies, if concerns arise with the stage-based thermoelectric cooling process, such as large temperature gradients in the material, thermal insulating material (silicone) will be added between the individual wells of the plate to increase the thermal inertia and reduce the rate of heat transfer between the material in the well plate and the surroundings. The CubeLab version of the HTC platform also contains integrated temperature sensing capabilities to ensure uniform heating of well plates (see the Operational Approach Section).

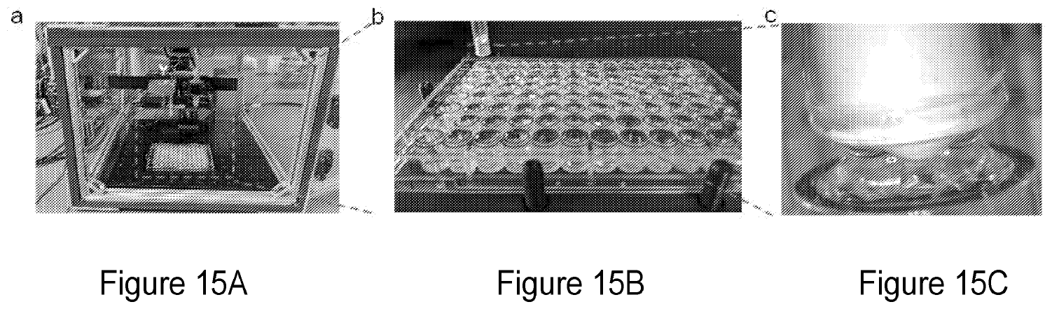

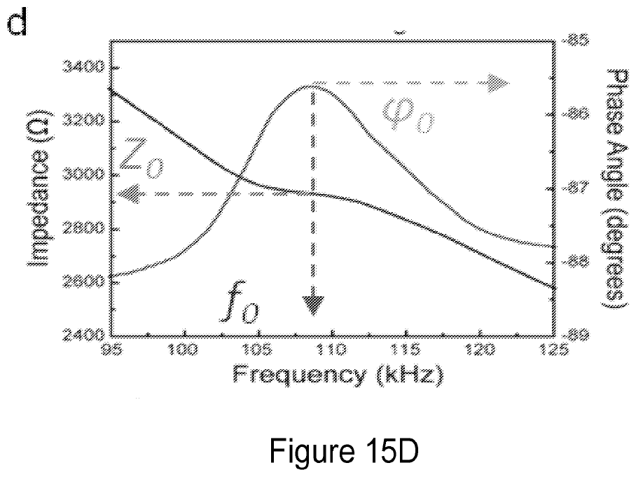

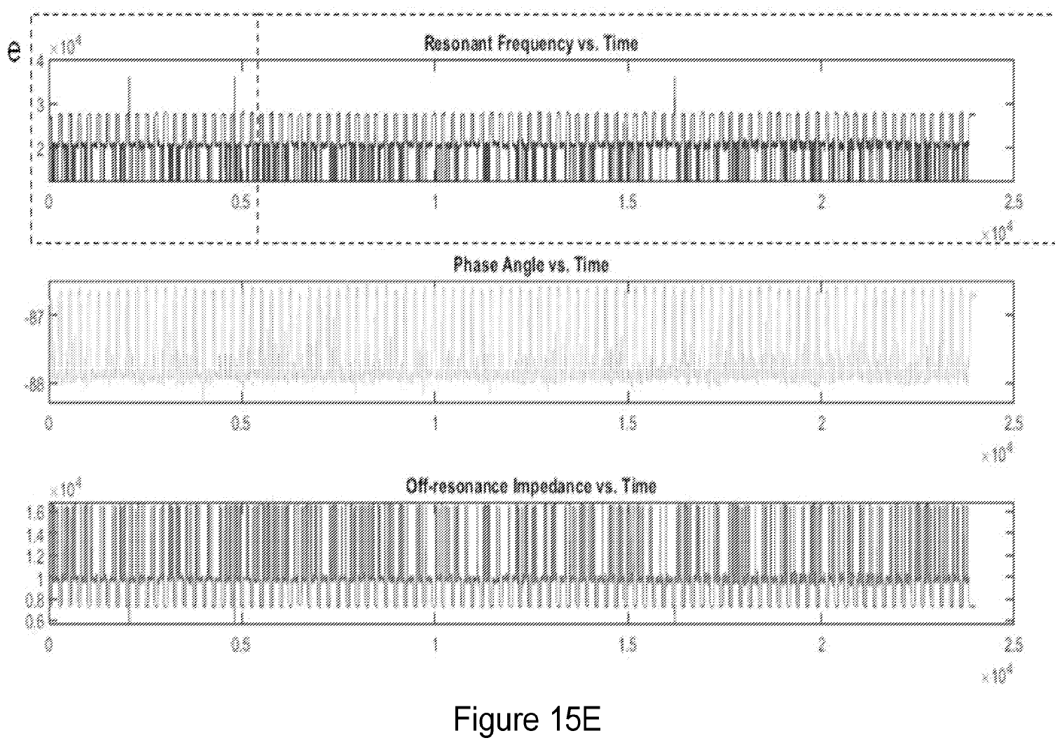

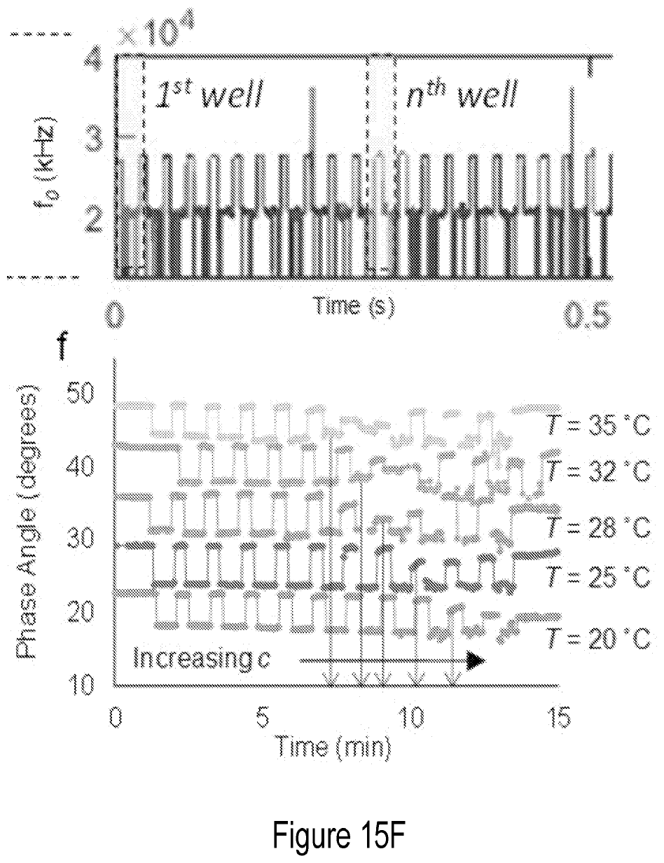

Proof-of-Concept Studies (Preliminary Data): Photographs of the ground version of the sensor-based HTC platform and the associated well-plate measurement format are shown in FIGS. 15A-15C. Continuous tracking of the sensor impedance response near resonance (see FIG. 4D) enables real-time monitoring of the sensor resonant frequency, phase angle, and impedance. Representative sensor time-series data is shown in FIG. 15E. As shown in FIG. 15F, we have used the sensor-based HTC platform to characterize sol-gel phase transition diagrams for various hydrogels (data shown for Pluronic F127 hydrogels, which is a well-established system that has been used extensively in tissue and pharmaceutical engineering applications). The measurement took 384 min (6.4 hr) per temperature increment based on the previously described tool path.

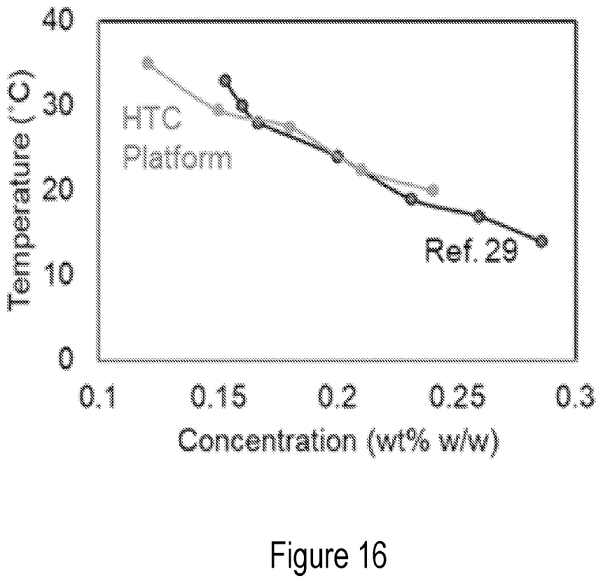

As shown in FIG. 16, the sol-gel phase transition data obtained using the HTC platform agrees within the standard error of previously reported data that was obtained using alternative low-throughput characterization approaches (see e.g., reference Gioffredia et al. 2016). The measurement can be made using different sensors within a batch and among different batches. In addition, the time-to-results (TTR) can be improved by a factor of four by decreasing the stabilization and dwell times in the tool path. Thus, the measurement time per temperature increment can be reduced to 1.6 hr. In addition to HTC of thermoreversible hydrogels, the system also can be applied to HTC of chemical- and photo-gelation processes using alginate and PEGDA hydrogels, respectively (data not shown). Following contact with sol or gel, the sensor can be removed from the well and subsequently used.

Given the fact that the concentration of the wells are known a priori, potential effects of mass transfer between adjacent wells during the measurement can be corrected for using the sensor's resonant frequency response which enables quantification of added-mass effects as Δmₙ=−0.5mₙΔfₙ/fₙ, where Δfₙ is the resonant frequency shift, mₙ is the effective mass of the cantilever for the n^{th} mode, and Δmₙ is the added mass. A positive correlation can be established between low- and high-frequency viscoelastic properties, ranging from 1 Hz (DMA acquired; Q800; TA Instruments) to ˜100 kHz (sensor acquired). PEMC sensors exhibit resonant modes from 10 kHz to 1.2 MHz, thereby enabling characterization of hydrogel viscoelastic properties over two orders of magnitude.

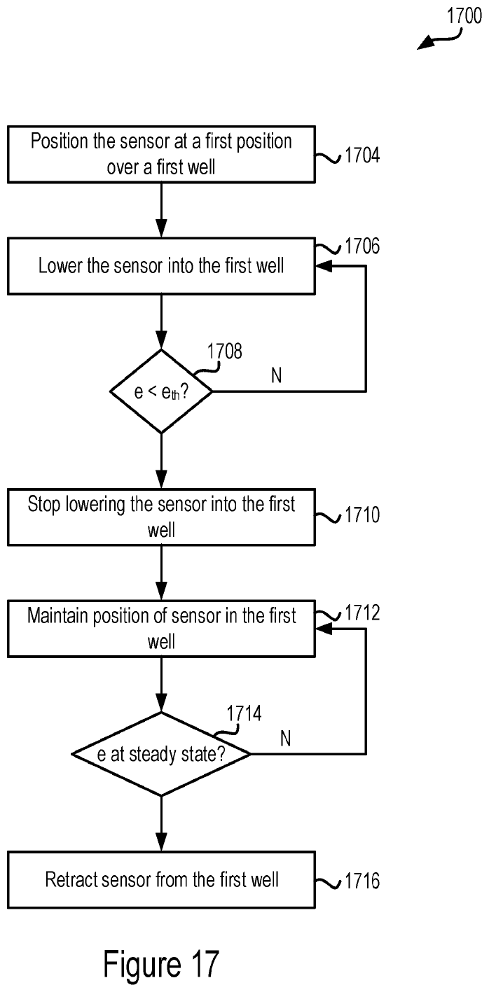

FIG. 17 shows a flow diagram of an example process 1700 for measuring material properties of a plurality of samples. In particular, the process 1700 can be executed by one or more processors coupled with memory that can store instructions corresponding to at least a portion of the process 1700. The process 1700, for example, can be executed by a controller that controls the position of the sensor. The controller can include a stan-alone programmed controller that can control the robotic structure as well as receive data from the sensor. In some examples, the controller can be a software tool such as Matlab or LabView that can be programmed to control the operation of the robotic structure as well as the operation of any data acquisition equipment, signal generator, voltage supply, or other electronic devices coupled to the system, and in particular to the sensor. The process includes positioning the sensor at a first position over a first well (1704). In particular, the controller can instruct the three-axis robotic structure to position the sensor at a first position that is over the first well. The first position can be a few centimeters/inches over the first well 1402 shown in FIG. 14A, however, any position that ensures that the sensor is not in contact with the sample in the first well can be used. The process 1700 further includes lowering the sensor into the first well (1706). For example, the controller can send instructions to the robotic structure to move the sensor in a direction that includes a vertical component and that immerses the sensor into the sample in the first well. The process 1700 further includes continuing the lower the sensor into the first well until a threshold condition is met. In particular, the controller can continue to instruct the robotic structure to lower the sensor into the well until one or more electrical parameters (e) of the senor is below a submersion threshold value (eₜₕ) (1708). The electrical parameters can include those discussed above such as the resonant frequency, the impedance, phase angle, quality factor, etc. If the controller determines that the value of one or more electrical parameters is below a predetermined threshold value, the controller can instruct the robotic system to stop lowering the sensor (1710). The submersion threshold value can correspond to a position of the sensor in the sample that indicates that completely immerses the sensor cantilever into the sample. The threshold value can be experimentally determined and stored in memory for access by the controller.

The process further includes maintaining the position of the senor in the first well 1402 (1712). The controller can maintain the sensor position in the first well to continue to acquire the electrical parameters that can be translated into the material properties of the sample. In some examples, the controller needs to maintain the sensor in the sample for only a time duration that is sufficient for acquiring a reliable reading. Any additional time spent in the first well can be wasteful, and can impact the total time needed for traversing all the wells in the well plate 1402. In some examples, the controller can determine when the retract the sensor based on whether the one or more electrical parameters have reached steady state value (1714). In one approach, the controller can determine a derivative, over a time window, of the one or more electrical parameters. The derivative can indicate the rate of change of the value of the electrical parameter. If the rate of change is below a threshold value, the controller can determine that the one or more electrical parameters has reached steady state. The threshold value can be determined experimentally and can include a value of rate of change that corresponds to a time in the well that provides readings at desired reliability. Once the controller determines that the one or more electrical parameters have reached steady state, the controller can instruct the robotic system to retract the sensor from the first well 1402 (1716). Traditional systems may set a fixed amount of time for which the sensor is immersed into the wells to measure the values of the electrical parameters. This, however, can cause an increase in the time per cell needed to capture the values of the electrical parameters, as the sensor may spend more time than that needed to capture reliable values from the sample. In contrast, the controller controls the sensor to remain in the sample for only as long as reliable values can be captured, and then retracts the sensor to move on to the next sensor. As a result, the time spent per cell to is reduced. In instances where the well plate include dozens of samples, even incremental decrease in per cell time can translate into large time savings and efficiency in characterizing the dozens of samples.

The controller, can store the time instance at which the retract instructions are sent as a time stamp at which the one or more electrical parameters can be used to characterize the sample within the first well. The controller after retracting the sensor from the first well 1402, can position the sensor over the second well 1404 and carry out the same process discussed above to lower and then retract the sensor from the second well 1404. In this manner, the controller can lower the sensor to capture values of the electrical parameters of the plurality of samples in the well plate.

In some example, the effectiveness of the sensor to measure the electrical properties of the samples can be diminished because of the adherence of the sample on the sensor. For example, the sensor after being immersed in one or more sample fluids can have some quantities of the sample fluid adhered onto the sensor. As a result, when the senor is immersed into a different sample, the previous sample adhered onto the sensor may affect or alter the readings for the current sample. Thus, the controller can occasionally immerse the sensor into a washing fluid, such as water, to wash off the samples from the surface of the sensor. In one example, the controller can immerse the sensor in a well that includes water between any two samples. In some instances, the controller can immerse the sensor in the washing fluid after taking readings in two or more samples. In some instances, the well plate can be filled with the washing fluid in appropriate wells along the sensor path 1408 such that the frequency at which the controller washes the sensor is predetermined. In some instances, the controller can dynamically determine when the sensor needs washing. For example, the controller can measure the values of the one or more electrical parameters of the sensor to determine whether the sensor needs washing. In some examples, the controller can measure the values of the one or more electrical parameters when the sensor is completely retracted from the sample and is assumed to be in air. If the value of the one or more electrical parameter is below a threshold value, the controller can determine that the sensor needs cleaning. The threshold value can be experimentally determined by adhering to the sensor to several quantities of sample substance and determining the corresponding values of the electrical parameters. The value below which the sensor does not provide reliable readings can be set as the threshold value. Once the controller determines that the value of the one or more electrical parameters is below the threshold value, the controller can refrain from immersing the sensor into another well containing a sample in the sensor path, but instead move the sensor over any of one or more wells that include a washing fluid and immerse the sensor in the washing fluid. The controller can immerse the sensor in the washing fluid for a predetermined time that is sufficient for cleaning the sensor or can monitor the electrical parameters and determine the time required for cleaning based on the instantaneous values of the electrical parameters. Once the sensor is cleaned, the controller can then resume the sensor path 1408 from its last position in the sensor path 1408 and continue to characterize samples in the well until the last sample has been characterized.

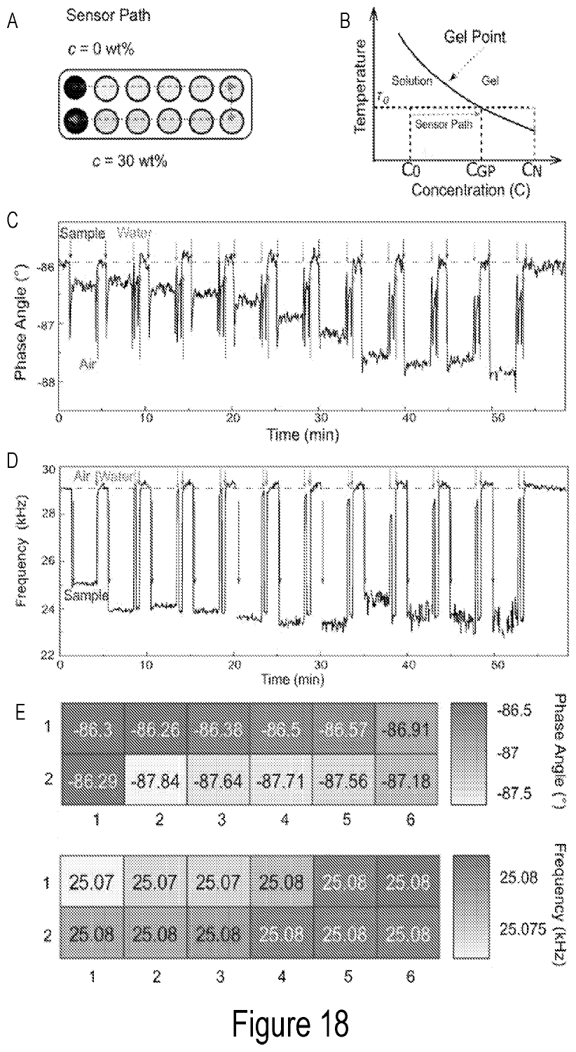

FIGS. 18A-E show results of characterization by the controller for a set of samples. In particular, FIG. 18A shows the sensor path traversed by the sensor for various samples with various concentrations. FIG. 18B shows the corresponding sol-gel phase transition diagram. FIGS. 18C and 18D show example plots of the electrical parameters (phase angle and frequency) of the sensor determined real time at various instances during the traversal of the sensor path. The electrical parameters can be seen to change based on whether the sensor is immersed in a sample, is in air, or is in water (the example washing fluid). For example, the frequency changes significantly when the sensor is immersed into a sample from an immediately previous position in air. The controller, as discussed above, can monitor at least this electrical parameter to determine whether the sensor is completely immersed in the sample by comparing the value of the electrical parameter with the submersion threshold value. In the example shown in FIG. 18A, the sensor is immersed in a washing fluid after each sample. That is, the controller washes the sensor after immersing the sensor in one sample. FIG. 18E shows a matrix of values of the electrical parameters determined for each sample in the sensor path.

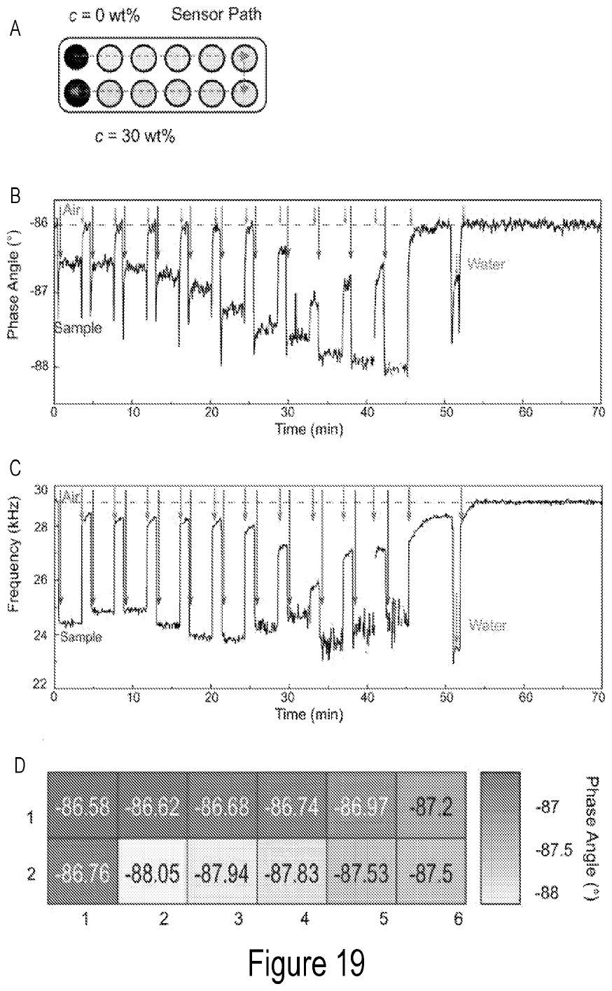

FIGS. 19A-19D show results of characterization by the controller of another set of samples. In contrast with the characterization depicted in FIGS. 18A-18E, the characterization depicted in FIGS. 19A-19E take the approach of washing the sensor only after the sensor has been used to characterize all 12 samples. For example, as shown in FIG. 19B, the sensor is immersed in water only after the sensor has been immersed in all the samples. Refraining from repeatedly washing the sensor can result in the deterioration of the electrical signals in terms of amplitude and signal-to-noise ratio. The controller can compare the values of the electrical parameters with threshold values discussed above to determine whether the sensor needs a wash.

The approaches discussed above can be used for determining material properties of samples, and not just rheological properties. In particular, the approaches above can be used to determine physical properties (e.g., density, dielectric properties, etc.), mechanical properties (e.g., rheological properties), and molecular properties (e.g., binding constants), and structural data related to the samples. As an example, Campbell and Muthurasan (Detection and quantification of proteins using self-excited PZT-glass millimeter-sized cantilever, Biosensors and Bioelectronics 21 (2005), 597-607) discuss deriving molecular properties of a sample from the electrical parameters measured by the sensor when immersed in the sample. For example, the electrical parameters can be used to determine a binding reaction rate constant associated with proteins in the sample. One feature of the sensor discussed herein is that its resonant frequency is dependent on its mass. The controller can measure this resonant frequency in the sample while protein reacts or binds with the sensing glass cantilever surface. In some other instances, the approach discussed above also can be used to determine thermodynamic parameters associated with the binding reaction such as, for example, the entropy and enthalpy. Johnson and Muthurasan (pH Effect on Protein G Orientation on Gold Surfaces and Characterization of Adsorption Thermodynamics, ACS Journal of Surfaces and Colloids, 18 Apr. 2012, 28(17): 6928-6934) in equation 3 deriving the enthalpy based on resonance frequency shifts of a sensor in a sample. Thus, the above approach can be utilized to make high throughput characterizations of not only the physical and mechanical properties, but also molecular properties of a large set of samples.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

References: All cited references, patent or literature, are incorporated by reference in their entirety. The examples disclosed herein are illustrative and not limiting in nature. Details disclosed with respect to the methods described herein included in one example or embodiment may be applied to other examples and embodiments. Any aspect of the present disclosure that has been described herein may be disclaimed, i.e., exclude from the claimed subject matter whether by proviso or otherwise.
1. Abu-Zahra, N. H., “Real-time viscosity and density measurements of polymer melts using dielectric and ultrasound sensors fusion,” Mechatronics 14, 789-803 (2004).
2. Ahmed, J., “Rheological properties of gelatin and advances in measurement.” Advances in Food Rheology and Its Applications (Elsevier, 2017).
3. Bakarich, S. E., Gorkin III, R., Panhuis, M. i. h., and Spinks, G. M., “4D Printing with Mechanically Robust, Thermally Actuating Hydrogels,” Macromolecular Rapid Communications 36, 1211-1217 (2015).
4. Belalia, F., and Djelali, N.-E., “Rheological properties of sodium alginate solutions,” Revue Roumaine de Chimie 59, 135-145 (2014).
5. Belmiloud, N., Dufour, I., Nicu, L., Colin, A., and Pistre, J., “Vibrating microcantilever used as viscometer and microrheometer,” 2006.
6. Bonino, C. A., Samorezov, J. E., Jeon, O., Alsberg, E., and Khan, S. A., “Real-time in situ rheology of alginate hydrogel photocrosslinking,” Soft Matter 7, 11510-11517 (2011).
7. Boontheekul, T., Kong, H.-J., and Mooney, D. J., “Controlling alginate gel degradation utilizing partial oxidation and bimodal molecular weight distribution,” Biomaterials 26, 2455-2465 (2005).
8. Boskovic, S., Chon, J., Mulvaney, P., and Sader, J., “Rheological measurements using microcantilevers,” Journal of Rheology 46, 891-899 (2002).
9. Brinson, H. F., and Brinson, L. C., Polymer engineering science and viscoelasticity (Springer, 2015).
10. Calvet, D., Wong, J. Y., and Giasson, S., “Rheological monitoring of polyacrylamide gelation: Importance of cross-link density and temperature,” Macromolecules 37, 7762-7771 (2004).
11. Chon, J. W., Mulvaney, P., and Sader, J. E., “Experimental validation of theoretical models for the frequency response of atomic force microscope cantilever beams immersed in fluids,” Journal of applied physics 87, 3978-3988 (2000).
12. Chu, W., “Tech Rep No. 2, DTMB, contract NObs-86396 (X),” Southwest Research Institute, San Antonio, Texas 94 (1963).
13. Craighead, H., “Nanomechanical systems: Measuring more than mass,” Nature nanotechnology 2, 18 (2007).
14. de Carvalho, W., and Djabourov, M., “Physical gelation under shear for gelatin gels,” Rheologica Acta 36, 591-609 (1997).
15. de Pablo, J. J., Jackson, N. E., Webb, M. A., Chen, L.-Q., Moore, J. E., Morgan, D., Jacobs, R., Pollock, T., Schlom, D. G., and Toberer, E. S., “New frontiers for the materials genome initiative,” npj Computational Materials 5, 41 (2019).
16. Djabourov, M., Leblond, J., and Papon, P., “Gelation of aqueous gelatin solutions. I. Structural investigation,” Journal de physique 49, 319-332 (1988).
17. Drury, J. L., and Mooney, D. J., “Hydrogels for tissue engineering: scaffold design variables and applications,” Biomaterials 24, 4337-4351 (2003).
18. Duan, B., Hockaday, L. A., Kang, K. H., and Butcher, J. T., “3D bioprinting of heterogeneous aortic valve conduits with alginate/gelatin hydrogels,” Journal of biomedical materials research Part A 101, 1255-1264 (2013).
19. Duan, P., Kandemir, N., Wang, J., and Chen, J., “Rheological Characterization of Alginate Based Hydrogels for Tissue Engineering,” MRS Advances 2, 1309-1314 (2017).
20. Dufour, I., Maali, A., Amarouchene, Y., Ayela, C., Caillard, B., Darwiche, A., Guirardel, M., Kellay, H., Lemaire, E., and Mathieu, F., “The microcantilever: A versatile tool for measuring the rheological properties of complex fluids,” Journal of Sensors 2012 (2012).
21. Fonkwe, L. G., Narsimhan, G., and Cha, A. S., “Characterization of gelation time and texture of gelatin and gelatin—polysaccharide mixed gels,” Food Hydrocolloids 17, 871-883 (2003).
22. Fritz, J., “Cantilever biosensors,” analyst 133, 855-863 (2008).
23. Gerlach, G., Guenther, M., Sorber, J., Suchaneck, G., Arndt, K.-F., and Richter, A., “Chemical and pH sensors based on the swelling behavior of hydrogels,” Sensors and Actuators B: Chemical 111, 555-561 (2005).
24. Gladman, A. S., Matsumoto, E. A., Nuzzo, R. G., Mahadevan, L., and Lewis, J. A., “Biomimetic 4D printing,” Nature materials 15, 413 (2016).
25. Green, M. L., Choi, C., Hattrick-Simpers, J., Joshi, A., Takeuchi, I., Barron, S., Campo, E., Chiang, T., Empedocles, S., and Gregoire, J., “Fulfilling the promise of the materials genome initiative with high-throughput experimental methodologies,” Applied Physics Reviews 4, 011105 (2017).
26. Gupta, P., Vermani, K., and Garg, S., “Hydrogels: from controlled release to pH-responsive drug delivery,” Drug Discovery Today 7, 569-579 (2002).
27. Haring, A. P., Sontheimer, H., and Johnson, B. N., “Microphysiological Human Brain and Neural Systems-on-a-Chip: Potential Alternatives to Small Animal Models and Emerging Platforms for Drug Discovery and Personalized Medicine,” Stem Cell Reviews and Reports 13, 381-406 (2017).
28. Haring, A. P., Thompson, E. G., Tong, Y., Laheri, S., Cesewski, E., Sontheimer, H., and Johnson, B. N., “Process- and bio-inspired hydrogels for 3D bioprinting of soft free-standing neural and glial tissues,” Biofabrication 11, 025009 (2019).
29. Harini, M., and Deshpande, A. P., “Rheology of poly (sodium acrylate) hydrogels during cross-linking with and without cellulose microfibrils,” Journal of Rheology 53, 31-47 (2009).
30. Highley, C. B., Rodell, C. B., and Burdick, J. A., “Direct 3D Printing of Shear-Thinning Hydrogels into Self-Healing Hydrogels,” Advanced Materials 27, 5075-5079 (2015).
31. Hill, A. V., “The combinations of haemoglobin with oxygen and with carbon monoxide. I,” Biochemical Journal 7, 471 (1913).
32. Hoffman, A. S., “Hydrogels for biomedical applications,” Advanced drug delivery reviews 64, 18-23 (2012).
33. Itoh, T., Lee, C., and Suga, T., “Deflection detection and feedback actuation using a self-excited piezoelectric Pb (Zr, Ti) O3 microcantilever for dynamic scanning force microscopy,” Applied physics letters 69, 2036-2038 (1996).
34. Jain, M., Schmidt, S., and Grimes, C. A., “Magneto-acoustic sensors for measurement of liquid temperature, viscosity and density,” Applied Acoustics 62, 1001-1011 (2001).
35. Jakoby, B., and Vellekoop, M. J., “Physical sensors for liquid properties,” IEEE sensors journal 11, 3076-3085 (2011).
36. Janmey, P. A., Georges, P. C., and Hvidt, S., “Basic rheology for biologists,” Methods in cell biology 83, 1-27 (2007).
37. Johnson, B. N., and Mutharasan, R., “The origin of low-order and high-order impedance-coupled resonant modes in piezoelectric-excited millimeter-sized cantilever (PEMC) sensors: Experiments and finite element models,” Sensors and Actuators B: Chemical 155, 868-877 (2011).
38. Johnson, B. N., and Mutharasan, R., “Persistence of bending and torsional modes in piezoelectric-excited millimeter-sized cantilever (PEMC) sensors in viscous liquids-1 to 103 cP,” Journal of Applied Physics 109, 066105 (2011).
39. Johnson, B. N., and Mutharasan, R., “Biosensing using dynamic-mode cantilever sensors: A review,” Biosensors and Bioelectronics 32, 1-18 (2012).
40. Johnson, B. N., Sharma, H., and Mutharasan, R., “Torsional and Lateral Resonant Modes of Cantilevers as Biosensors: Alternatives to Bending Modes,” Analytical Chemistry 85, 1760-1766 (2013).
41. Junior, E. A. P., Davila, J. L., and d'Avila, M. A., “Rheological studies on nanocrystalline cellulose/alginate suspensions,” Journal of Molecular Liquids 277, 418-423 (2019).
42. Kim, H. G., “Dielectric cure monitoring for glass/polyester prepreg composites,” Composite structures 57, 91-99 (2002).
43. Kuo, C. K., and Ma, P. X., “Ionically crosslinked alginate hydrogels as scaffolds for tissue engineering: Part 1. Structure, gelation rate and mechanical properties,” Biomaterials 22, 511-521 (2001).
44. Lang, H. P., Hegner, M., and Gerber, C., “Cantilever array sensors,” Materials today 8, 30-36 (2005).
45. Lee, J., Cuddihy, M. J., and Kotov, N. A., “Three-dimensional cell culture matrices: state of the art,” Tissue Engineering Part B: Reviews 14, 61-86 (2008).
46. Lee, K. Y., and Mooney, D. J., “Hydrogels for tissue engineering,” Chemical reviews 101, 1869-1880 (2001).
47. Li, J., and Mooney, D. J., “Designing hydrogels for controlled drug delivery,” Nature Reviews Materials 1, 16071 (2016).
48. Maali, A., Hurth, C., Boisgard, R., Jai, C., Cohen-Bouhacina, T., and Aimé, J.-P., “Hydrodynamics of oscillating atomic force microscopy cantilevers in viscous fluids,” Journal of Applied Physics 97, 074907 (2005).
49. Madhumitha, G., Fowsiya, J., and Roopan, S. M., “Emerging Technology in Medical Applications of Hydrogel,” in Thakur, V. K. and Thakur, M. K. (eds). Hydrogels: Recent Advances (Springer Singapore, Singapore, 2018).
50. Mather, M. L., Rides, M., Allen, C. R., and Tomlins, P. E., “Liquid viscoelasticity probed by a mesoscale piezoelectric bimorph cantilever,” Journal of Rheology 56, 99-112 (2012).
51. Nemir, S., Hayenga, H. N., and West, J. L., “PEGDA hydrogels with patterned elasticity: Novel tools for the study of cell response to substrate rigidity,” Biotechnology and bioengineering 105, 636-644 (2010).
52. Nowack, B., and Sigg, L., “Adsorption of EDTA and metal—EDTA complexes onto goethite,” Journal of Colloid and Interface Science 177, 106-121 (1996).
53. Raiteri, R., Grattarola, M., Butt, H.-J., and Skládal, P., “Micromechanical cantilever-based biosensors,” Sensors and Actuators B: Chemical 79, 115-126 (2001).
54. Richter, A., Paschew, G., Klatt, S., Lienig, J., Arndt, K.-F., and Adler, H.-J. P., “Review on hydrogel-based pH sensors and microsensors,” Sensors 8, 561-581 (2008).
55. Sader, J. E., “Frequency response of cantilever beams immersed in viscous fluids with applications to the atomic force microscope,” Journal of applied physics 84, 64-76 (1998).
56. Sharma, H., Lakshmanan, R. S., Johnson, B. N., and Mutharasan, R., “Piezoelectric cantilever sensors with asymmetric anchor exhibit picogram sensitivity in liquids,” Sensors and Actuators B: Chemical 153, 64-70 (2011).
57. Simon, A., Grohens, Y., Vandanjon, L., Bourseau, P., Balnois, E., and Levesque, G., “A comparative study of the rheological and structural properties of gelatin gels of mammalian and fish origins,” 2003.
58. Singamaneni, S., LeMieux, M. C., Lang, H. P., Gerber, C., Lam, Y., Zauscher, S., Datskos, P. G., Lavrik, N. V., Jiang, H., and Naik, R. R., “Bimaterial microcantilevers as a hybrid sensing platform,” Advanced Materials 20, 653-680 (2008).
59. Stephan, A. M., “Review on gel polymer electrolytes for lithium batteries,” European polymer journal 42, 21-42 (2006).
60. Tibbitt, M. W., and Anseth, K. S., “Hydrogels as extracellular matrix mimics for 3D cell culture,” Biotechnology and bioengineering 103, 655-663 (2009).
61. Tosh, S. M., and Marangoni, A. G., “Determination of the maximum gelation temperature in gelatin gels,” Applied Physics Letters 84, 4242-4244 (2004).
62. Wu, H., Yu, G., Pan, L., Liu, N., McDowell, M. T., Bao, Z., and Cui, Y., “Stable Li-ion battery anodes by in-situ polymerization of conducting hydrogel to conformally coat silicon nanoparticles,” Nature communications 4, 1943 (2013).
63. Xu, Y., Lin, Z., Huang, X., Wang, Y., Huang, Y., and Duan, X., “Functionalized graphene hydrogel-based high-performance supercapacitors,” Advanced materials 25, 5779-5784 (2013).
64. Zhang, X., and Xiang, Y., “Combinatorial approaches for high-throughput characterization of mechanical properties,” Journal of Materiomics 3, 209-220 (2017).
65. Zhang, Y. S., and Khademhosseini, A., “Advances in engineering hydrogels,” Science 356, eaaf3627 (2017).
66. Ervin, J. S., Merte, H., Keller, R. B. & Kirk, K. Transient pool boiling in microgravity. International Journal of Heat and Mass Transfer 35, 659-674, (1992).
67. Pienaar, C. L., Chiffoleau, G. J. A., Follens, L. R. A., Martens, J. A., Kirschhock, C. E. A. & Steinberg, T. A. Effect of Gravity on the Gelation of Silica Sols. Chem. Mater. 19, 660-664, (2007).
68. McPherson, A., J. Malkin, A., Kuznetsov, Y. G., Koszelak, S., Wells, M., Jenkins, G., Howard, J. & Lawson, G. The effects of microgravity on protein crystallization: evidence for concentration gradients around growing crystals. Journal of Crystal Growth 196, 572-586, (1999).
69. McPherson, A. & DeLucas, L. J. Microgravity protein crystallization. NPJ Microgravity 1, 15010, (2015).
70. Kawanishi, K., Komatsu, M. & Inoue, T. Thermodynamic consideration of the sol-gel transition in polymer solutions. Polymer 28, 980-984, (1987).
71. Pogodina, N. V. & Winter, H. H. Polypropylene Crystallization as a Physical Gelation Process. Macromolecules 31, 8164-8172, (1998).
72.7 Nunes, C., Roedersheimer, M., Simske, S. & Luttges, M. Effect of microgravity, temperature, and concentration on fibrin and collagen assembly. Microgravity Sci Technol. 8, 125-130, (1995).
73. Meseguer, J., Sanz-Andres, A., Perez-Grande, I., Pindado, S., Franchini, S. & Alonso, G. Surface tension and microgravity. European Journal of Physics 35, 055010, (2014).
74. Brutin, D., Zhu, Z., Rahli, O., Xie, J., Liu, Q. & Tadrist, L. Sessile Drop in Microgravity: Creation, Contact Angle and Interface. Microgravity Science and Technology 21, 67-76, (2009).
75. Calvimontes, A. The measurement of the surface energy of solids using a laboratory drop tower. npj Microgravity 3, 25, (2017).
76. Chen, S., Han, Z., Duan, L. & Kang, Q. Experimental and numerical study on capillary flow along deflectors in plate surface tension tanks in microgravity environment. AIP Advances 9, 025020, (2019).
77. Ababneh, A., Amirfazli, A. & Elliott, J. A. W. Effect of Gravity on the Macroscopic Advancing Contact Angle of Sessile Drops. Canadian Journal of Chemical Engineering 84, 39-43, (2006).
78. Pollara, L. Z. Surface Tension and Vapor Pressure. The Journal of Physical Chemistry 46, 1163-1167, (1942).
79. McElroy, P. Surface Tension and Its Effect on Vapor Pressure. Journal of Colloid and Interface Science 72, 147-149, (1979).
80. Do, V. T. & Straub, J. Surface tension, coexistence curve, and vapor pressure of binary liquid-gas mixtures. International Journal of Thermophysics 7, 41-51, (1986).
81. Makkonen, L. A thermodynamic model of contact angle hysteresis. The Journal of Chemical Physics 147, 064703, (2017).
82. R. F. Curl, J. & Pitzer, K. S. Volumetric and Thermodynamic Properties of Fluids—Enthalpy, Free Energy, and Entropy. Industrial and Engineering Chemistry 50, 265-274, (1958).
83. Calvimontes, A. The Thermodynamic Characterization of Wetting by Submitting a Sessile Drop to Microgravity. Preprints 2017080062, doi: 2017080010.2017020944/preprints2017201708.2017080062.v2017080062, (2017).
84. Good, R. J. Surface Entropy and Surface Orientatin of Polar Liquids. Journal of Physical Chemistry 61, 810-813, (1956).
85. Hong, K. M. & Noolandi, J. Conformational Entropy Effects in a Compressible Lattice Fluid Theory of Polymers. Macromolecules 1981, 1229-1234, (1981).
86. Tabor, D. P., Roch, L. M., Saikin, S. K., Kreisbeck, C., Sheberla, D., Montoya, J. H., Dwaraknath, S., Aykol, M., Ortiz, C., Tribukait, H., Amador-Bedolla, C., Brabec, C. J., Maruyama, B., Persson, K. A. & Aspuru-Guzik, A. Accelerating the discovery of materials for clean energy in the era of smart automation. Nature Reviews Materials 3, 5-20, (2018).
87. Richman, E. K. & Hutchison, J. E. The Nanomaterial Characterization Bottleneck. ACS Nano 3, 2441-2446, (2009).
88. de Pablo, J. J., Jackson, N. E., Webb, M. A., Chen, L.-Q., Moore, J. E., Morgan, D., Jacobs, R., Pollock, T., Schlom, D. G., Toberer, E. S., Analytis, J., Dabo, I., DeLongchamp, D. M., Fiete, G. A., Grason, G. M., Hautier, G., Mo, Y., Rajan, K., Reed, E. J., Rodriguez, E., Stevanovic, V., Suntivich, J., Thornton, K. & Zhao, J.-C. New frontiers for the materials genome initiative. npj Computational Materials 5, 41, (2019).
89. Lyu, Y., Liu, Y., Cheng, T. & Guo, B. High-throughput characterization methods for lithium batteries. Journal of Materiomics 3, 221-229, (2017).
90. Ludwig, A., Cao, J., Brugger, J. & Takeuchi, I. MEMS tools for combinatorial materials processing and high-throughput characterization. Measurement Science and Technology 16, 111-118, (2004).
91. Materials Genome Initiative for Global Competitiveness. 1-18 (Office of Science and Technology Policy, Washington, DC, 2011).
92. Designing Materials to Revolutionize and Engineer our Future (DMREF), <https://www.nsf.gov/funding/pgm_summ.jsp?pims_id=505073> (2019).
93. Accelerated Molecular Discovery (AMD), <https://www.darpa.mil/program/accelerated-molecular-discovery> (2019).
94. Gioffredia, E., Boffitoa, M., Calzonea, S., Giannitellib, S. M., Rainerb, A., Trombettab, M., Mozeticb, P. & Chiono, V. Pluronic F127 hydrogel characterization and biofabrication in cellularized constructs for tissue engineering applications. Procedia CIRP 49, 125-132, (2016).
95. Ohkura, M., Kanaya, T. & Keisuke, K. Gels of poly(vinyl alcohol) from dimethyl sulphoxide/water solutions. Polymer 33, 3686-3690, (1992).
96. Choi, J. H., Ko, S.-W., Kim, B. C., Blackwell, J. & Lyoo, W. S. Phase Behavior and Physical Gelation of High Molecular Weight Syndiotactic Poly(vinyl alcohol) Solution. Macromolecules 34, 2964-2972, (2001).
97. Shibatani, K. Gel Formation and Structure of Junctions in Poly(vinyl alcohol)—Water Systems. Polymer Journal 1, 348-355, (1970).
98. Tanaka, T., Swislow, G. & Ohmine, I. Phase Separation and Gelation in Gelatin Gels. Phys. Rev. Lett. 42, 1556-1559, (1979).
99. Parker, N. G. & Povey, M. J. W. Ultrasonic study of the gelation of gelatin: Phase diagram, hysteresis and kinetics. Food Hydrocolloids 26, 99-107, (2012).
100. Bansil, R., Lal, J. & Carvalho, B. L. Effects of gelation on spinodal decomposition kinetics in gelatin. Polymer 33, 2961-2969, (1992).
101. Sanwlani, S., Kumar, P. & Bohidar, H. B. Hydration of Gelatin Molecules in Glycerol—Water Solvent and Phase Diagram of Gelatin Organogels. The Journal of Physical Chemistry B 115, 7332-7340, (2011).
102. Takahashi, M., Shimazaki, M. & Yamamoto, J. Thermoreversible gelation and phase separation in aqueous methyl cellulose solutions. Journal of Polymer Science Part B: Polymer Physics 39, 91-100, (2001).
103. Arvidson, S. A., Lott, J. R., McAllister, J. W., Zhang, J., Bates, F. S., Lodge, T. P., Sammler, R. L., Li, Y. & Brackhagen, M. Interplay of Phase Separation and Thermoreversible Gelation in Aqueous Methylcellulose Solutions. Macromolecules 46, 300-309, (2013).
104. Mutharasan, R., Xu, S., Johnson, B. N., Sharma, H. & Lakshmanan, R. S. Detection and measurement of mass change using an electromechanical resonator U.S. patent (2010).
105. Johnson, B. N. & Mutharasan, R. Persistence of bending and torsional modes in piezoelectric-excited millimeter-sized cantilever (PEMC) sensors in viscous liquids-1 to 10(3) cP. J. Appl. Phys. 109, 066105, (2011).
106. Sharma, H., Lakshmanan, R. S., Johnson, B. N. & Mutharasan, R. Piezoelectric cantilever sensors with asymmetric anchor exhibit picogram sensitivity in liquids. Sens. Actuators B 153, 64-70, (2011).
107. Johnson, B. N. & Mutharasan, R. The origin of low-order and high-order impedance-coupled resonant modes in piezoelectric-excited millimeter-sized cantilever (PEMC) sensors: Experiments and finite element models. Sens. Actuators B 155, 868-877, (2011).
108. Johnson, B. N. & Mutharasan, R. A novel experimental technique for determining node location in resonant mode cantilevers. J. Micromech. Microeng. 21, 065027, (2011).
109. Johnson, B. N., Sharma, H. & Mutharasan, R. Torsional and lateral resonant modes of cantilevers as biosensors: Alternatives to bending modes. Anal. Chem. 85, 1760-1766, (2013).
110. Johnson, B. N. & Mutharasan, R. Electrochemical piezoelectric-excited millimeter-sized cantilever (ePEMC) for simultaneous dual transduction biosensing. Analyst 138, 6365-6371, (2013).
111. Itoh, T., Lee, C. & Suga, T. Deflection detection and feedback actuation using a self-excited piezoelectric Pb(Zr,Ti)O3 microcantilever for dynamic scanning force microscopy. Appl. Phys. Lett. 69, 2036-2038, (1996).
112. Itoh, T. & Suga, T. Self-excited force-sensing microcantilevers with piezoelectric thin films for dynamic scanning force microscopy. Sens. Actuators A 54, 477-481, (1996).
113. Looker, J. R. & Sader, J. E. Flexural resonant frequencies of thin rectangular cantilever plates. Journal of Applied Mechanics-Transactions of the ASME 75, (2008).
114. Van Eysden, C. A. & Sader, J. E. Frequency response of cantilever beams immersed in compressible fluids with applications to the atomic force microscope. J. Appl. Phys. 106, 094904, (2009).
115. Clauset, A., Shalizi, C. R. & Newman, M. E. J. Power-Law Distributions in Empirical Data. SIAM Rev. 51, 661-703, (2009).
116. Charan, J. & Kantharia, N. D. How to calculate sample size in animal studies? Journal of Pharmacology & Pharmacotherapeutics 4, 303-306, (2013).
117. Sambandam, Y., Townsend, M. T., Pierce, J. J., Lipman, C. M., Hague, A., Bateman, T. A. & Reddy, S. V. Microgravity control of autophagy modulates osteoclastogenesis. Bone 61, 125-131, (2014).
118. Nislow, C., Lee, A. Y., Allen, P. L., Giaever, G., Smith, A., Gebbia, M., Stodieck, L. S., Hammond, J. S., Birdsall, H. H. & Hammond, T. G. Genes Required for Survival in Microgravity Revealed by Genome-Wide Yeast Deletion Collections Cultured during Spaceflight. BioMed Research International 2015, 10, (2015).
119. Sharma, C. S., Sarkar, S., Periyakaruppan, A., Ravichandran, P., Sadanandan, B., Ramesh, V., Thomas, R., Hall, J. C., Wilson, B. L. & Ramesh, G. T. Simulated microgravity activates apoptosis and NF-κB in mice testis. Molecular and Cellular Biochemistry 313, 71-78, (2008).
120. Snell, E. H., Judge, R. A., Crawford, L., Forsythe, E. L., Pusey, M. L., Sportiello, M., Todd, P., Bellamy, H., Lovelace, J., Cassanto, J. M. & Borgstahl, G. E. O. Investigating the Effect of Impurities on Macromolecule Crystal Growth in Microgravity. Crystal Growth & Design 1, 151-158, (2001).
121. Mather, M. L., Rides, M., Allen, C. R. G. & Tomlins, P. E. Liquid viscoelasticity probed by a mesoscale piezoelectric bimorph cantilever. Journal of Rheology 56, 99-112, (2012).
122. Arnau, A., Jimenez, Y. & Sogorb, T. An extended Butterworth Van Dyke model for quartz crystal microbalance applications in viscoelastic fluid media. IEEE T. Ultrason. Ferr. 48, 1367-1382, (2001).
123. Suntornnond, R., An, J. & Chua, C. K. Bioprinting of Thermoresponsive Hydrogels for Next Generation Tissue Engineering: A Review. Macromolecular Materials and Engineering 302, 1600266, (2017).
124. Tanaka, F. Theory of thermoreversible gelation. Macromolecules 22, 1988-1994, (1989).
125. Tanaka, F. Thermodynamic Theory of Network-Forming Polymer Solutions. 1. Macromolecules 23, 3784-3789, (1990).

1. A system for measuring physical material properties of a plurality of samples, comprising:
a three-axis robotic structure for moving the target to a desired position in a three-dimensional space;
a piezoelectric millimeter cantilever sensor mounted on the three-axis robotic structure, the piezoelectric millimeter cantilever sensor configured to have at least one electrical parameter as a function of its physical environment; and
a controller coupled with the three-axis robotic structure, the controller configured to:
instruct the three-axis robotic structure to position the millimeter cantilever sensor at a first position over a first well including a first fluid sample,
instruct the three-axis robotic structure to lower the piezoelectric millimeter cantilever sensor into the first fluid sample,
instruct the three-axis robotic structure to retract the piezoelectric millimeter cantilever sensor from the first fluid sample and move the piezoelectric millimeter cantilever sensor over a second position over a second well including a second fluid sample, and
instruct the three-axis robotic structure to lower the piezoelectric millimeter cantilever sensor into the second fluid sample.

2. The system of claim 1, wherein the controller is further configured to:
measure at least one electrical parameter associated with the piezoelectric millimeter cantilever sensor when the piezoelectric millimeter cantilever sensor is lowered into each of the first fluid sample and the second fluid sample.

3. The system of claim 1, wherein the controller is further configured to:
measure a first set of electrical parameters associated with the piezoelectric millimeter cantilever sensor after instructing the three-axis robotic structure to lower the piezoelectric millimeter cantilever sensor into the first fluid sample,
determine that a value of at least one electrical parameter from the set of electrical parameters is in a steady state, and
based on determining that the value is in a steady state, instruct the three-axis robotic structure to retract the piezoelectric millimeter cantilever sensor from the first fluid sample.

4. The system of claim 3, wherein the controller is configured to:
determine that the value of the at least one electrical parameter from the set of electrical parameters is in the steady state based on determining that a rate of change of the value of the at least one electrical parameter from the set of electrical parameters is below a threshold value.

5. The system of claim 1, wherein the controller is further configured to:
prior to instructing the three-axis robotic structure to move the piezoelectric millimeter cantilever over the second position over the second well, instruct the three-axis robotic structure to lower and retract the piezoelectric millimeter cantilever sensor into a third well having a washing fluid.

6. The system of claim 5, wherein the controller is further configured to:
determine that a value of at least one electrical parameter after instructing the three-axis robotic structure to retract the piezoelectric millimeter cantilever sensor from the first fluid sample,
determine that the value of the at least one electrical parameter is below a threshold value, and
based on determining that the value of the at least one electrical parameter is below the threshold value, instruct the three-axis robotic structure to lower the piezoelectric millimeter cantilever sensor into the third well having the washing fluid.

7. The system of claim 1, wherein the controller is further configured to:
repeatedly measure a value of at least one electrical parameter associated with the piezoelectric millimeter cantilever sensor after instructing the three-axis robotic structure to lower the piezoelectric millimeter cantilever sensor into the first fluid sample, and
instruct the three-axis robotic structure to stop lowering the piezoelectric millimeter cantilever sensor into the first fluid sample upon determining that the value of the at least one electrical parameter is less than a submersion threshold value.

8. The system of claim 1, further comprising:
a well plate including a plurality of wells, including the first well and the second well, each well of the plurality of well having an opening that can accommodate at least a portion of the piezoelectric millimeter cantilever sensor.

9. A method for measuring physical material properties of a plurality of samples using a system including a three-axis robotic structure for moving the target to a desired position in a three-dimensional space, and a piezoelectric millimeter cantilever sensor mounted on the three-axis robotic structure, the piezoelectric millimeter cantilever sensor configured to have at least one electrical parameter as a function of its physical environment, the method comprising:
positioning, by the three-axis robotic structure, the millimeter cantilever sensor at a first position over a first well including a first fluid sample;
lowering, by the three-axis robotic structure, the piezoelectric millimeter cantilever sensor into the first fluid sample;
retracting, by the three-axis robotic structure, the piezoelectric millimeter cantilever sensor from the first fluid sample and moving the piezoelectric millimeter cantilever sensor over a second position over a second well including a second fluid sample; and
lowering, by the three-axis robotic structure, the piezoelectric millimeter cantilever sensor into the second fluid sample.

10. The method of claim 9, further comprising:
measuring at least one electrical parameter associated with the piezoelectric millimeter cantilever sensor when the piezoelectric millimeter cantilever sensor is lowered into each of the first fluid sample and the second fluid sample.

11. The method of claim 9, further comprising:
measuring a first set of electrical parameters associated with the piezoelectric millimeter cantilever sensor after lowering the piezoelectric millimeter cantilever sensor into the first fluid sample;
determining that a value of at least one electrical parameter from the set of electrical parameters is in a steady state; and
retracting, based on determining that the value is in a steady state, the piezoelectric millimeter cantilever sensor from the first fluid sample.

12. The method of claim 11, further comprising:
determining that the value of the at least one electrical parameter from the set of electrical parameters is in the steady state based on determining that a rate of change of the value of the at least one electrical parameter from the set of electrical parameters is below a threshold value.

13. The method of claim 9, further comprising:
prior to moving the piezoelectric millimeter cantilever over the second position over the second well, lowering, by the three-axis robotic structure, the piezoelectric millimeter cantilever sensor into a third well having a washing fluid.

14. The method of claim 13, further comprising:
determining that a value of at least one electrical parameter retracting the piezoelectric millimeter cantilever sensor from the first fluid sample;
determining that the value of the at least one electrical parameter is below a threshold value; and
based on determining that the value of the at least one electrical parameter is below the threshold value, lowering, by the three-axis robotic structure, the piezoelectric millimeter cantilever sensor into the third well having the washing fluid.

15. The method of claim 9, further comprising:
repeatedly measuring a value of at least one electrical parameter associated with the piezoelectric millimeter cantilever sensor after lowering the piezoelectric millimeter cantilever sensor into the first fluid sample; and
stop lowering the piezoelectric millimeter cantilever sensor into the first fluid sample upon determining that the value of the at least one electrical parameter is less than a submersion threshold value.

16. A non-volatile computer readable memory including instructions, which when executed by one or more processors, cause the one or more processors to execute a method comprising:
positioning, by a three-axis robotic structure, a millimeter cantilever sensor at a first position over a first well including a first fluid sample, wherein the three-axis robotic structure is configured to moving a target to a desired position in a three-dimensional space, and wherein the piezoelectric millimeter cantilever sensor is mounted on the three-axis robotic structure and is configured to have at least one electrical parameter as a function of its physical environment;
lowering, by the three-axis robotic structure, the piezoelectric millimeter cantilever sensor into the first fluid sample;
retracting, by the three-axis robotic structure, the piezoelectric millimeter cantilever sensor from the first fluid sample and moving the piezoelectric millimeter cantilever sensor over a second position over a second well including a second fluid sample; and
lowering, by the three-axis robotic structure, the piezoelectric millimeter cantilever sensor into the second fluid sample.

17. The non-volatile computer readable memory of claim 16, the method further comprising:
measuring at least one electrical parameter associated with the piezoelectric millimeter cantilever sensor when the piezoelectric millimeter cantilever sensor is lowered into each of the first fluid sample and the second fluid sample.

18. The non-volatile computer readable memory of claim 16, the method further comprising:
measuring a first set of electrical parameters associated with the piezoelectric millimeter cantilever sensor after lowering the piezoelectric millimeter cantilever sensor into the first fluid sample;
determining that a value of at least one electrical parameter from the set of electrical parameters is in a steady state; and
retracting, based on determining that the value is in a steady state, the piezoelectric millimeter cantilever sensor from the first fluid sample.

19. The non-volatile computer readable memory of claim 16, the method further comprising:
determining that the value of the at least one electrical parameter from the set of electrical parameters is in the steady state based on determining that a rate of change of the value of the at least one electrical parameter from the set of electrical parameters is below a threshold value.

20. The non-volatile computer readable memory of claim 16, further comprising:
prior to moving the piezoelectric millimeter cantilever over the second position over the second well, lowering, by the three-axis robotic structure, the piezoelectric millimeter cantilever sensor into a third well having a washing fluid.
